(19) United States
(12) Patent Application Publication
(10) Pub. No.: US 2023/0069641 A1
(43) Pub. Date: Mar. 2, 2023

(54) CONNECTOR AND CONTAINMENT SYSTEM FOR A PORTABLE FREE-STANDING SKATING RINK

(71) Applicants: Dylan Gastel, Boston, MA (US); Jason Stricker, West Newton, MA (US)

(72) Inventors: Dylan Gastel, Boston, MA (US); Jason Stricker, West Newton, MA (US)

(73) Assignee: Dylan Gastel, Boston, MA (US)

(21) Appl. No.: 17/896,537

(22) Filed: Aug. 26, 2022

Related U.S. Application Data
(60) Provisional application No. 63/239,058, filed on Aug. 31, 2021.

(51) Int. Cl. A63C 19/10; F16B 5/06

(52) U.S. Cl. CPC A63C 19/10; F16B 5/0621

(57) ABSTRACT

A connector for removably securing and vertically stacking perimeter components of a skating rink. The connector includes an elongated body extending a length from a first axial end to a second axial end along an axis thereof. The length is selected to span a height of at least two perimeter components. A first anchoring feature extends at least a portion of the length into or along a first lateral side of the elongated body. A second anchoring feature extends at least a portion of the length into or along a second lateral side of the elongated body.

### CROSS REFERENCE TO RELATED APPLICATIONS

The present application is a non-provisional application of, and claims priority to, commonly owned and co-pending U.S. Provisional Patent Application No. 63/239,058, filed Aug. 31, 2021, the contents of which are incorporated herein by reference in its entirety.

### TECHNICAL FIELD

The present invention is directed to a connector and containment system for a portable free-standing skating rink and more particularly to a connector for aligning, removably joining and vertically stacking and stabilizing multiple perimeter components and for removably securing an ancillary containment structure (e.g., netting) to the skating rink.

### BACKGROUND

Ice hockey and ice skating in general are increasingly popular in cold climates. The demand for ice time is so high compared with supply in many regions that teams and other clubs/groups must rent ice time during very early morning hours or very late nighttime hours. Many programs, especially those run by public high schools have been forced to reduce practice ice time hours or even eliminate entire programs due to increased costs to obtain ice time, particularly in view of reduced budgets.

Traditionally, hockey players and other skaters have used frozen lakes or ponds on which to skate during the winter months. In addition, families, towns, and other associations have flooded fields or parking lots to form ice on which to skate. Skating on lakes and ponds can be extremely dangerous. Also, flooding a permeable field or lot is not feasible in regions where the ice will melt and then refreeze throughout the winter, as the water will drain once the ice intermittently melts.

There are presently many complicated methods for constructing an outdoor ice rink. These usually involve constructing some sort of perimeter inside of which an impermeable liner is optionally laid. This open-top container is then partially filled with water, which freezes into ice in the rough shape of an ice rink. These perimeters are usually constructed of some combination of plywood, lumber, spikes, stakes, screws, and nails. Moreover, these perimeters are usually of limited height (e.g., one to two feet tall) which does not suffice to contain pucks that have high projectile paths and do not provide a suitable containment wall for ice skaters. In hockey checking is a move wherein a player drives the shoulder, upper arm and hip and elbow, equally into the opponent to separate them from the puck or using the body to knock an opponent against the boards. The perimeters of prior art portable, free-standing ice-skating rinks are too short to provide a wall for checking an opponent into the boards.

It is apparent from the above that there is a need for an improved portable, free-standing skating rink that can be constructed with suitable containment systems.

### SUMMARY

The present invention according to an embodiment includes a connector for removably securing and vertically stacking and stabilizing perimeter components of a skating rink. The connector includes an elongated body extending a length from a first axial end to a second axial end along an axis thereof. The length is selected to span a height of at least two perimeter components. A first anchoring feature extends at least a portion of the length into or along a first lateral side of the elongated body. A second anchoring feature extends at least a portion of the length into or along a second lateral side of the elongated body.

In some embodiments, the first anchoring feature includes a first groove, and the second anchoring feature includes a second groove. In some embodiments, the first groove includes a first slot defined by a first pair of opposing interior walls, and the second groove includes a second slot defined by a second pair of opposing interior walls. In some embodiments, the first slot extends inwardly from the first lateral side towards the second slot, and the second slot extends inwardly from the second lateral side towards the first slot. In some embodiments, the first groove includes a first area of increased cross-section that extends inwardly from the first slot, and the second groove includes a second area of increased cross-section that extends inwardly from the second slot. In some embodiments, the first anchoring feature is a mirror image of the second anchoring feature. In some embodiments, the first anchoring feature is oriented 180 degrees from the second anchoring feature. In some embodiments, the first anchoring feature is oriented 90 degrees from the second anchoring feature. In some embodiments, the elongated body is substantially hollow and includes a gusset configuration connecting the first anchoring feature to the second anchoring feature. In some embodiments, the elongated body includes a front face and a back face that is substantially parallel to the front face. In some embodiments, the front face and the back face are connected to one another by a gusset configuration. In some embodiments, the first anchoring feature and the second anchoring feature are contained between the front face and the back face. In some embodiments, the first lateral side includes two first shoulders, and the second lateral side includes two second shoulders. In some embodiments, the two first shoulders are configured to abut and stabilize at least two first perimeter components, and the two second shoulders are configured to abut and stabilize at least two second perimeter components. In some embodiments, the first anchoring feature includes a first groove, and the second anchoring feature includes a protuberance). In some embodiments, the first anchoring feature is oriented 180 degrees from the second anchoring feature. In some embodiments, the first anchoring feature is oriented 90 degrees from the second anchoring feature. In some embodiments, the first groove includes a slot defined by a first pair of opposing interior walls, and the protuberance includes a necked-in area defined by a second pair of opposing interior walls that terminate in a bulbous head. In some embodiments, the slot extends inwardly from the first lateral side towards the protuberance, and the protuberance extends outwardly away from the slot. In some embodiments, the first groove comprises a first area of increased cross-section that extends inwardly from the slot. In some embodiments, the first anchoring feature with the first groove and the second anchoring feature with the protuberance extend along a first portion of the elongated body, another first groove extends along a second portion of the elongated body on the first lateral side, and a second groove extends along the second portion of the elongated body on the second lateral side. In some embodiments, the first portion is equal to about one third of the length of the elongated body, and the second portion is equal to about two thirds of the length of the elongated body. In some embodiments, the first groove extends the entire length along the first lateral side. In some embodiments, the second groove extends the entire length along the second lateral side.

The present invention according to an embodiment includes a pole support for receiving at least one pole. The pole support includes a base having at least one aperture extending therethrough; and at least one fastener extending therefrom. The at least one fastener is configured to removably engage the first anchoring feature and the second anchoring feature of the connector).

In some embodiments, the at least one fastener includes a gripping feature having radially inwardly biasing members.

The present invention according to an embodiment includes a multi-stacked perimeter assembly for a skating rink. The assembly includes the connector; a first pair of first perimeter components removably joined by the connector; and a second pair of second perimeter components stacked vertically on top of the first pair of first perimeter components and removably joined by the connector.

In some embodiments, the multi-stacked perimeter assembly includes a third pair of third perimeter components stacked vertically on top of the second pair of second perimeter components and removably joined by the connector. In some embodiments, the multi-stacked perimeter assembly includes a third pair of perimeter components stacked vertically on top of one of the second pair of perimeter components and removably joined to the connector.

The present invention according to an embodiment includes a multi-stacked perimeter assembly for a skating rink. The assembly includes the connector; a first pair of first perimeter components removably joined by the connector; and at least one perimeter component is stacked vertically on top of one of the first pair of first perimeter components and removably joined to the connector.

In some embodiments, the pole support includes a connector receiving aperture that has a contour configured to receive the connector.

The present invention according to an embodiment includes a pole support for receiving at least one pole. The pole support includes a base having an aperture formed therein; and a fastener extending inwardly from a perimeter of the aperture. The pole support is configured to interchangeably mate with a first one of the connector and a second one of the connector. The first anchoring feature of the first connector is oriented perpendicular to the second anchoring feature of the first connector. The first anchoring feature of the second connector is oriented perpendicular to the second anchoring feature of the second connector. The mating of the pole support with the first connector includes the first connector extending through the aperture and the first anchoring feature of the first connector being fastened to the fastener. The mating of the pole support with the second connector includes the second connector extending through the aperture and the first anchoring feature of the second connector being fastened to the fastener.

In some embodiments, the fastener is male, the first anchoring feature of the first connector is female, and the first anchoring feature of the second connector is female. In some embodiments, the second anchoring feature of the first connector is female, and the second anchoring feature of the second connector is male. In some embodiments, the fastener includes a flange. In some embodiments, the first anchoring feature of the first connector includes a first groove, the second anchoring feature of the first connector includes a second groove, the first anchoring feature of the second connector includes a third groove, and the second anchoring feature of the second connector includes a protuberance. In some embodiments, the aperture being configured to interchangeably mate with the first connector and the second connector enables mating of the aperture with the first connector at a first time and mating of the aperture with the second connector at a second time. In some embodiments, a cross sectional area of the aperture is smaller than a sum of a cross sectional area of the first connector and a cross sectional area of the second connector.

In some embodiments, the multi-stacked perimeter assembly includes at least one pole support removably joined to the connector. In some embodiments, the pole support is integrally formed with the connector. In some embodiments, the pole support extends along a width of the connector. In some embodiments, the multi-stacked perimeter assembly further includes at least one pole vertically and removably secured in the pole support. In some embodiments, the multi-stacked perimeter assembly further includes a containment barrier removably coupled to the pole. In some embodiments, the containment barrier includes a net system.

The present invention according to an embodiment includes a multi-stacked perimeter assembly for a skating rink. The assembly includes a first one of the connector; a first perimeter component having a first width and being configured to be removably attached to a first side of the first connector; and a second perimeter component having a second width and being configured to be removably attached to a second side of the first connector. The first width is greater than the second width.

In some embodiments, the multi-stacked perimeter assembly further includes a second one of the connector. In some embodiments, the second perimeter component is further configured to be removably attached to a first side of the second connector. In some embodiments, the multi-stacked perimeter assembly further includes a third perimeter component having a third width and being configured to be removably attached to a second side of the second connector. In some embodiments, the multi-stacked perimeter assembly further includes a fourth perimeter component having the first width and being configured to be removably attached to the first side of the first connector and stacked on top of the first perimeter component. In some embodiments, the multi-stacked perimeter assembly further includes a fifth perimeter component having the second width and being configured to be removably attached to the second side of the first connector, removably attached to the first side of the second connector, and stacked on top of the second perimeter component. In some embodiments, the multi-stacked perimeter assembly further includes a sixth perimeter component having the third width and being configured to be removably attached to the second side of the second connector and stacked on top of the third perimeter component. In some embodiments, the multi-stacked perimeter assembly further includes a seventh perimeter component having the first width and being configured to be removably attached to the first side of the first connector and stacked on top of the fourth perimeter component. In some embodiments, the multi-stacked perimeter assembly further includes an eighth perimeter component having a fourth width and being configured to be removably attached to the second side of the first connector and stacked on top of the fifth perimeter component, the second connector, and the sixth perimeter component. In some embodiments, the fourth width is equal to a sum of the second width, a width of the second connector, and the third width.

The present invention according to an embodiment includes a multi-stacked perimeter assembly for a skating rink. The assembly includes the connector; a first perimeter component having a first height and being configured to be removably attached to a first side of the connector; and a second perimeter component having a second height and being configured to be removably attached to a second side of the connector. The first height is less than the second height.

In some embodiments, the multi-stacked perimeter assembly further includes a third perimeter component having a third height and being configured to be removably attached to the first side of the connector and stacked on top of the first perimeter component. In some embodiments, a sum of the first height and the third height is greater than the first height. In some embodiments, the multi-stacked perimeter assembly further includes a fourth perimeter component having a fourth height and being configured to be removably attached to the second side of the connector and stacked on top of the second perimeter component. In some embodiments, the sum of the first height and the third height is less than a sum of the second height and the fourth height. In some embodiments, the multi-stacked perimeter assembly further includes a fifth perimeter component having a fifth height and being configured to be removably attached to the first side of the connector and stacked on top of the third perimeter component. In some embodiments, a sum of the first height, the third height, and the fifth height is greater than the sum of the second height and the fourth height. In some embodiments, the multi-stacked perimeter assembly further includes a sixth perimeter component having a sixth height and being configured to be removably attached to the second side of the connector and stacked on top of the fourth perimeter component). In some embodiments, the sum of the first height, the third height, and the fifth height is equal to a sum of the second height, the fourth height, and the sixth height and is equal to a height of the connector.

The present invention according to an embodiment includes a multi-stacked perimeter assembly for a skating rink. The assembly includes a first perimeter component having a first height; a second perimeter component having a second height and being configured to be removably attached to the first perimeter component; and a third perimeter component having a third height and being configured to be removably attached to the second perimeter component and stacked on top of the first perimeter component. A sum of the first height and the third height is greater than the second height.

In some embodiments, the multi-stacked perimeter assembly further includes a fourth perimeter component having a fourth height and being configured to be removably attached to the third perimeter component and stacked on top of the second perimeter component. In some embodiments, the sum of the first height and the third height is less than a sum of the second height and the fourth height. In some embodiments, the multi-stacked perimeter assembly further comprising a fifth perimeter component having a fifth height and being configured to be removably attached to the fourth perimeter component and stacked on top of the third perimeter component. In some embodiments, a sum of the first height, the third height, and the fifth height is greater than a sum of the second height and the fourth height. In some embodiments, the multi-stacked perimeter assembly further includes a sixth perimeter component having a sixth height and being configured to be removably attached to the fifth perimeter component and stacked on top of the fourth perimeter component. In some embodiments, the sum of the first height, the third height, and the fifth height is equal to a sum of the second height, the fourth height, and the sixth height. In some embodiments, the attachment of the second perimeter component to the first perimeter component and the attachment of the attachment of the third perimeter component to the second perimeter component vertically stabilizes the third perimeter component.

### BRIEF DESCRIPTION OF THE DRAWINGS

FIG. 1A is a top cross-sectional view of the connector of the present invention shown connecting two perimeter components of an ice skating rink;

FIG. 1B is a side view of the connector of FIG. 1A taken across section 1B-1B;

FIG. 1C is a cross sectional view of the connector of FIG. 1A taken across section 1C-1C;

FIG. 2 is a perspective view of a multi-stacked perimeter assembly for an ice skating rink;

FIG. 3A is a top cross-sectional view of an alternate embodiment of the connector of the present invention;

FIG. 3B is a side view of the connector of FIG. 3A taken across section 3B-3B;

FIG. 3C is a side view of the connector of FIG. 3A taken across section 3C-3C;

FIG. 3D is a side view of a hybrid connector;

FIG. 4 is exploded perspective view of the connector of FIGS. 1A, 1B and 1C shown proximate six perimeter components of the ice skating rink;

FIG. 5 is a perspective view of a portion of the multi-stacked perimeter assembly of Detail 5 of FIG. 2 with the connector of FIGS. 1A, 1B and 1C;

FIG. 6 is an exploded perspective view of the connector of FIGS. 3A, 3B and 3C shown proximate six perimeter components of the ice skating rink;

FIG. 7 is a perspective view of a portion of the multi-stacked perimeter assembly shown in FIG. 6 with the connector of FIGS. 3A, 3B and 3C;

FIG. 8 is an exploded perspective view of the connector of FIG. 3D shown proximate multiple perimeter components;

FIG. 9 is a perspective view of a portion of the multi-stacked perimeter assembly shown in FIG. 8 with the connector of FIG. 3;

FIG. 10A is a perspective view of a pole support with a flange fastener, according to the present invention;

FIG. 10B is a perspective view of a pole support with a bulbous fastener, according to the present invention;

FIG. 11 is a top front perspective view of the pole support of FIG. 8 shown assembled to the connector of FIGS. 1A, 1B and 1C;

FIG. 12 is a top rear perspective view of the pole support of FIG. 8 shown assembled to the connector of FIGS. 1A, 1B and 1C; and

FIG. 13 is a rear perspective view of a portion of the ice skating rink of the present invention shown with poles mounted in the pole supports of FIG. 8 and with netting secured to the poles.

FIG. 14 is a perspective view of a rink surrounded by the multi-stacked perimeter assembly.

FIG. 15A is a perspective view of a pole support according to another embodiment.

FIG. 15B is a top view of the pole support according to the embodiment of FIG. 15B.

FIG. 16 is perspective view of the multi-stacked perimeter assembly having the pole support according to the embodiment of FIG. 15A.

FIG. 17 is a front view of the multi-stacked perimeter assembly according to another embodiment.

FIG. 18A is a front view of the multi-stacked perimeter assembly according to yet another embodiment.

FIG. 18B is a front view of the multi-stacked perimeter assembly according to yet another embodiment.

FIG. 19A is a perspective view of the pole support according to an embodiment.

FIG. 19B is a top view of the pole support according to the embodiment of FIG. 19A.

FIG. 19C is a side view of the pole support according to the embodiment of FIG. 19A.

FIG. 19D is a front view of the pole support according to the embodiment of FIG. 19A.

FIG. 19E is a top view of the a usable with the pole support according to the embodiment of FIG. 19A.

FIG. 20A is a perspective view of a pole support according to yet another embodiment.

FIG. 20B is a top view of the pole support according to the embodiment of FIG. 20A.

FIG. 20C is a side view of the pole support according to the embodiment of FIG. 20A.

FIG. 20D is a front view of the pole support according to the embodiment of FIG. 20A.

FIG. 20E is a top view of a connector usable with the pole support according to the embodiment of FIG. 20A.

FIG. 20F is a top view of another connector usable with the pole support according to the embodiment of FIG. 20A.

FIG. 20G is a perspective view of the connector of the embodiment of FIG. 20E.

FIG. 20H is a perspective view of the connector according to the embodiment of FIG. 20F.

### DETAILED DESCRIPTION

According to an embodiment, there is provided a multi-stacked perimeter assembly for an ice-skating rink. The modular design of the multi-stacked perimeter assembly allows multiple perimeter components to be joined using connectors to surround the entire perimeter of the ice-skating rink. The modular design also allows the perimeter components to be stacked vertically to the desired height. Various embodiments will be described in detail below.

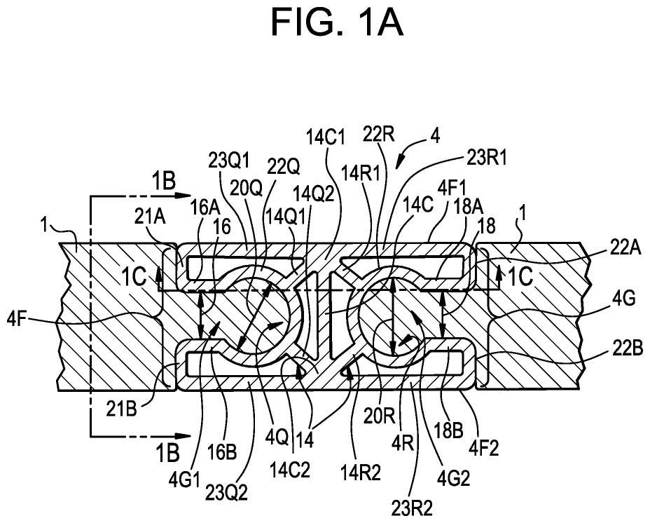

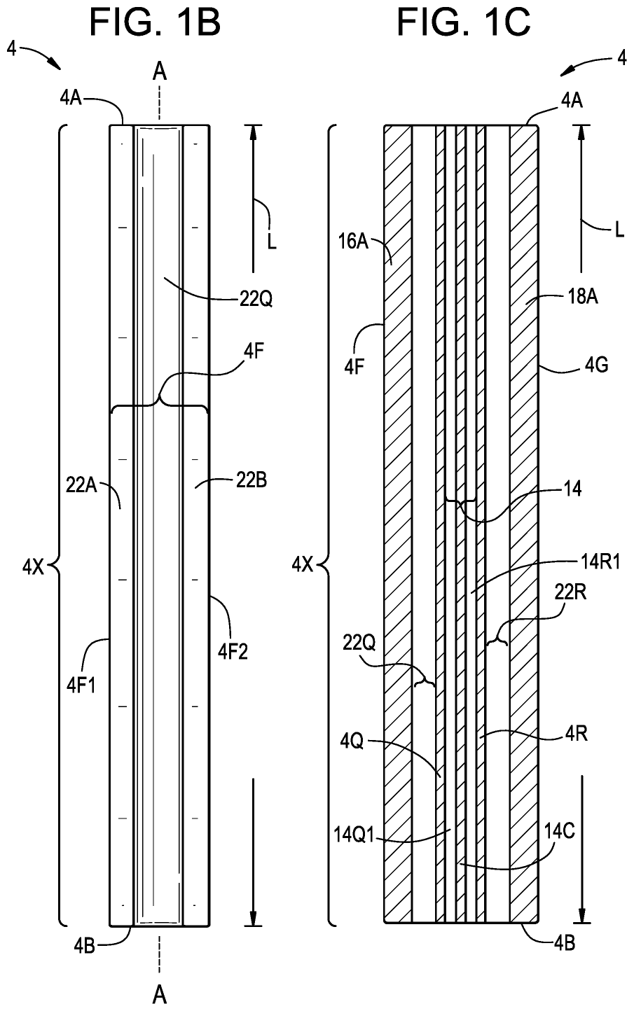

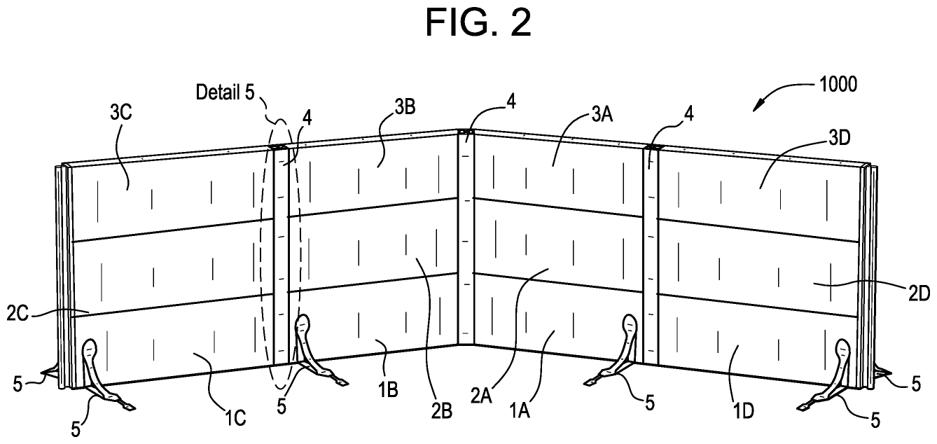

Referring to FIGS. 1A-1C, a connector 4 is provided for removably securing and vertically stacking (e.g., abutting long slender edges of adjacent perimeter components against one another) perimeter components 1 of the multi-stacked perimeter assembly 1000 shown in FIG. 2. The perimeter components 1 are, for example, plastic panels, hollow or solid plastic panels with or without ribs or indentations, boards or panels made of other materials. The connector 4 includes an elongated body 4X that extends a length L from a first axial end 4A to a second axial end 4B along an axis A thereof. A first anchoring feature 4Q extends at least a portion of the length L into, on or along a first lateral side 4F of the elongated body 4X. A second anchoring feature 4R extends at least a portion of the length L into, on or along a second lateral side 4G of the elongated body 4X. In one embodiment, the second anchoring feature 4R faces opposite to the first anchoring feature 4Q. The first anchoring feature 4Q is configured to anchor an object (e.g., one or more perimeter components 1) at the first lateral side 4F of the connector 4, and the second anchoring feature 4R is configured to anchor an object (e.g. one or more perimeter components) at the second lateral side 4G (e.g., opposite side or another side oriented at an angle, for example 90 degrees, to the first lateral side) of the connector 4.

In various embodiments, the first anchoring feature 4Q extends at least a portion of the length L along a first lateral side 4F of the elongated body 4X. In the embodiment of FIGS. 1B-1C, the first anchoring feature 4Q extends the entire length L along the first lateral side 4F of the elongated body 4X. The second anchoring feature 4R extends at least a portion of the length L along a second lateral side 4G of the elongated body 4X and faces opposite to the first anchoring feature 4Q. In the embodiment of FIGS. 1B-1C, the second anchoring feature 4R extends the entire length L along the second lateral side 4G of the elongated body 4X.

In the embodiment of FIG. 1A, the first anchoring feature 4Q is a mirror image of the second anchoring feature 4R, but asymmetrical configurations are also possible. For example, in some embodiments, the connector 4 is bent in an acute, right, or obtuse angle. Angled connectors 4 allow the multi-stacked perimeter assembly to conform to a perimeter of a skating rink. In some embodiments, the first anchoring feature 4Q is oriented 180 degrees from the second anchoring feature 4R. In some embodiments, the first anchoring feature 4Q is oriented 90 degrees from the second anchoring feature 4R.

The elongated body 4X is substantially hollow and comprises a gusset configuration 14 connecting the first anchoring feature 4Q to the second anchoring feature 104R. The gusset configuration 14 includes a center rib 14C, first structural ribs 14Q1, 14Q2, and second structural ribs 14R1, 14R2. The center rib 14C bisects the connector 4. The first structural ribs 14Q1, 14Q2 extend from opposite ends 14C1, 14C2 of the center rib 14C inward at oblique angles into an arc 22Q of first anchoring feature 4Q. That is, the first rib 14Q1 extends from the first end 14C1 of the center rib 14C and into the arc 22Q, and the first structural rib 14Q2 extends from the second end 14C2 of the center rib 14C and into the arc 22Q. The second structural ribs 14R1, 14R2 extend from opposite ends 14C1, 14C2 of the center rib 14C inward at oblique angles into an arc 22R the second anchoring feature 4R. That is, the structural rib 14R1 extends from the first end 14C1 of the center rib and into the arc 22R, and the second structural rib 14R2 extends from the second end 14C2 of the center rib and into the arc 22R. The arc 22Q is formed with an opening facing away from the center rib 14 and towards the first lateral side 4F. The arc 22R is formed with an opening facing away from the center rib 14 and towards the second lateral side 4G. Although the connector 4 shown in FIG. 1A is hollow, in other embodiments, the connector 4 is solid. In a preferred embodiment, the connector 4 is made out of plastic. However, in other embodiments, the connector 4 is made out of metal or another suitable material.

The first anchoring feature 4Q includes a first groove 4G1, and the second anchoring feature 4R includes a second groove 4G2. The first groove 4G1 includes a first slot 16 defined by a first pair of opposing interior walls 16A, 16B, and the second groove 4G1 includes a second slot 18 defined by a second pair of opposing interior walls 18A, 18B. The first slot 16 extends inwardly from the first lateral side 4F towards the second slot 18, and the second slot 18 extends inwardly from the second lateral side 4G towards the first slot 16. The first slot 16 and the second slot 18 are linear. The first groove 4G1 includes a first area of increased cross-section 20Q that extends inwardly from the first slot 16, and the second groove 4G2 includes a second area of increased cross-section 20R that extends inwardly from the second slot 18. The interior wall 16A extends from an end of the arc 22Q (proximate the opening of the arc 22Q) and towards the first lateral side 4F. The interior wall 16B extends from the other end of the arc 22Q (proximate the opening of the arc 22Q) and towards the first lateral side 4F. The interior wall 18A extends from an end of the arc 22R (proximate the opening of the arc 22R) and towards the second lateral side 4G. The interior wall 18B extends from the other end of the arc 22R (proximate the opening of the arc 22R) and towards the second lateral side 4G.

The elongated body 4X includes a front face 4F1 and a back face 4F2 that is substantially parallel to the front face 4F1. The front face 4F1 and the back face 4F2 are connected to one another by the gusset configuration 14. The first anchoring feature 4Q and the second anchoring feature 4R are contained between the front face 4F1 and the back face 4F2. The first lateral side 4F includes two first shoulders 21A, 21B, and the second lateral side 4G includes two second shoulders 22A, 22B. The shoulder 21A extends from an end of the interior wall 16A towards the front face 4F1. The shoulder 21B extends from an end of the interior wall 16B towards the back face 4F2. The shoulder 22A extends from an end of the interior wall 18A towards the front face 4F1. The shoulder 22B extends from the interior wall 18B towards the back face 4F2.

The first anchoring feature 4Q further includes exterior walls 23Q1 and 23Q2, and the second anchoring feature 4R includes exterior walls 23R1 and 23R2. The exterior wall 23Q1 extends from an end of the first shoulder 21A and into the first end 14C1 of the center rib 14C. The exterior wall 23Q2 extends from an end of the shoulder 21B and into the second end 14C2 of the center rib 14C. The exterior wall 23R1 extends from an end of the shoulder 22A and into the first end 14C1 of the center rib 14C. The exterior wall 23R2 extends from the shoulder 22B and into the second end 14C2 of the center rib.

The two first shoulders 21A, 21B are configured to abut and stabilize at least two first perimeter components 1, and the two second shoulders are configured to abut and stabilize at least two second perimeter components 1. The perimeter components 1 include a male component that is configured to mate with (e.g., slide into) the first anchoring feature 4Q or the second anchoring feature 4R, which are female.

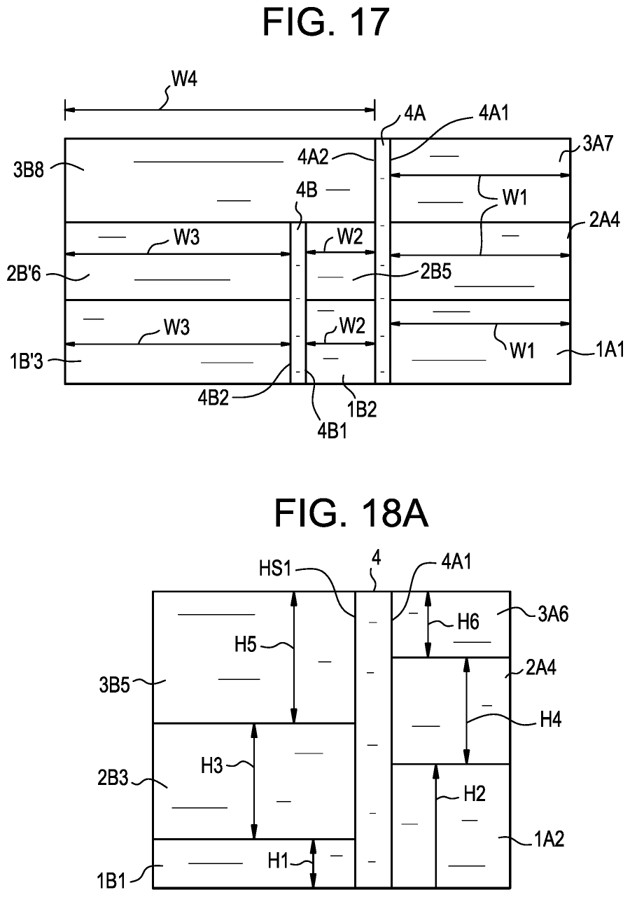

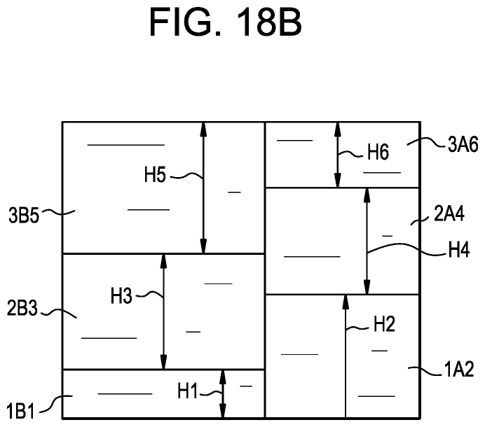

In some embodiments, the length L is selected to span the height of at least two perimeter components 1A, 1B. However, this is not intended to be limiting. In various embodiments, the length L is selected to span the height of one, two, four, five, six, or more perimeter components. In the exemplary embodiment of FIG. 2, the length L is selected to span the height of three perimeter components 1A, 1B, 1C. In the embodiment of FIG. 2, all of the perimeter components 1A, 2A, 3A, 1B, 2B, 3B, 1C, 2C, 3C, 1D, 2D, 3D are of the same dimension. In other embodiments, one or more of the perimeter components 1A, 2A, 3A, 1B, 2B, 3B, 1C, 2C, 3C, 1D, 2D, 3D are of different dimensions, for example as shown in FIGS. 17, 18A and 18B

By stacking multiple perimeter components and anchoring them with the connector 4, a multi-stacked perimeter assembly 1000 for an ice skating rink is constructed. A first pair of perimeter components 1A, 1B is removably joined by the connector 4, and a second pair of perimeter components 2A, 2B is vertically stacked on top of the first pair of perimeter components 1A, 1B and removably joined by the connector 4. A third pair of perimeter components 3A, 3B is vertically stacked on top of the second pair of perimeter components 2A, 2B and removably joined by the connector 4. In the same manner, a perimeter component 1C is attached to the connector 4 on an opposite side from perimeter component 1B. Perimeter component 2C is vertically stacked on top of perimeter component 1C and also connected to the connector 4. Perimeter component 3C is vertically stacked on top of perimeter component 2C and is also connected to the connector 4. In the same manner, perimeter component 1D is attached to the connector 4 on the opposite side from perimeter component 1A. Perimeter component 2D is vertically stacked on top of perimeter component 1D and also connected to the connector 4. Perimeter component 3D is vertically stacked on top of perimeter component 3D and is also connected to the connector 4. Holding member 5 are attached to the perimeter components 1A, 1B, 1C, and 1D on one or both sides. The holding member 5 are shaped as triangles and are configured to prevent the multi-stacked perimeter assembly 1000 from tipping over.

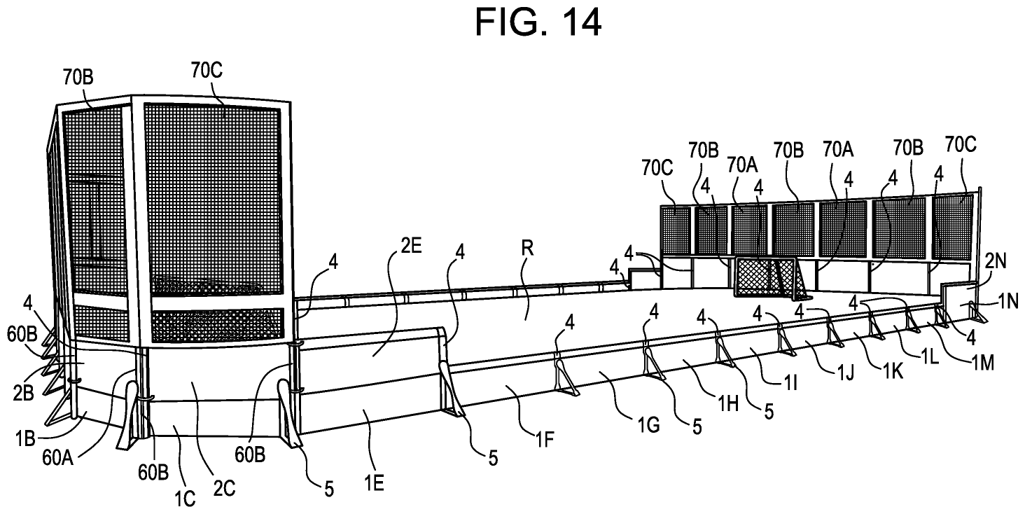

In some embodiments, the assembly process used to construct the multi-stacked perimeter assembly 1000 of FIG. 2 is continued to further lengthen the assembly 1000 until there is sufficient length for the assembly 1000 to completely encircle a skating rink as shown in FIG. 14. In FIG. 2, the perimeter components and the connector 4 are positioned to form a curve. In this example, the center connector 4 is curved or bent and connectors 4 on either side of the center connector 4 are straight. It is contemplated that in some embodiments, the perimeter components 1 are curved or bent to help form the overall shape of the multi-stacked perimeter assembly 1000. Other embodiments (not shown) of the multi-stacked perimeter assembly 1000 are formed in completely straight lines. In still other areas (not shown) of the multi-stacked perimeter assembly 1000, there may be irregular curves or sharp angles for covering an irregularly formed rink.

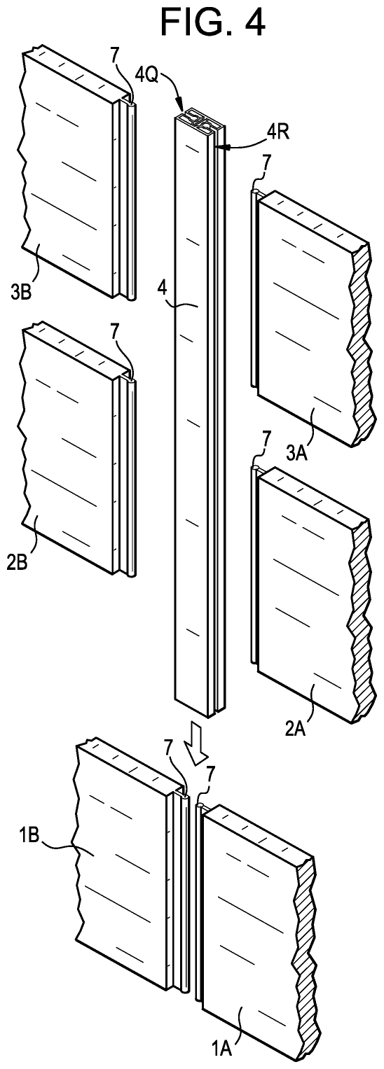

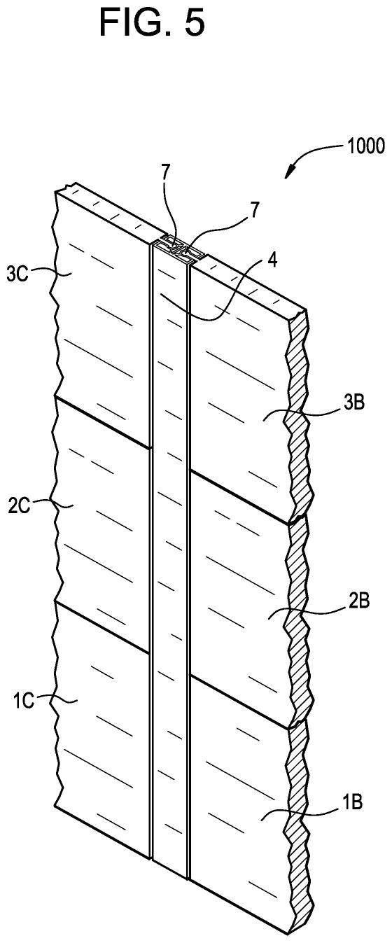

Referring to FIGS. 4-5, assembly of a portion of the multi-stacked perimeter assembly 1000 is illustrated in more detail. A tab 7 of the perimeter component 1A is slid into the second anchoring feature 4R of the connector 4, and a tab 7 of the perimeter component 1B is slid into the first anchoring feature 4Q of the connector 4. Similarly, a tab 7 of the perimeter component 2A is slid into the second anchoring feature 4R of the connector 4, and a tab 7 of the perimeter component 2B is slid into the first anchoring feature 4Q of the connector 4. Then, a tab 7 of the perimeter component 3A is slid into the second anchoring feature 4R of the connector 4, and a tab 7 of the perimeter component 3B is slid into the first anchoring feature 4Q of the connector 4. Other perimeter components and connectors 4 of the multi-stacked perimeter assembly 1000 are assembled in the same manner. In the embodiment of FIGS. 4-5, the tab 7 is in the form of a protuberance. The shape of the tab 7 is complimentary to the first anchoring feature 4Q or the second anchoring feature 4R. In other embodiments, the tab 7, the second anchoring features 4R, and the first anchoring feature 4Q have other shapes.

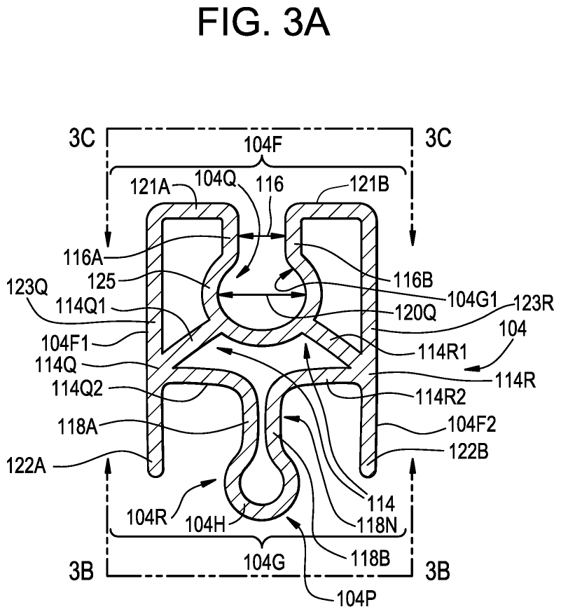

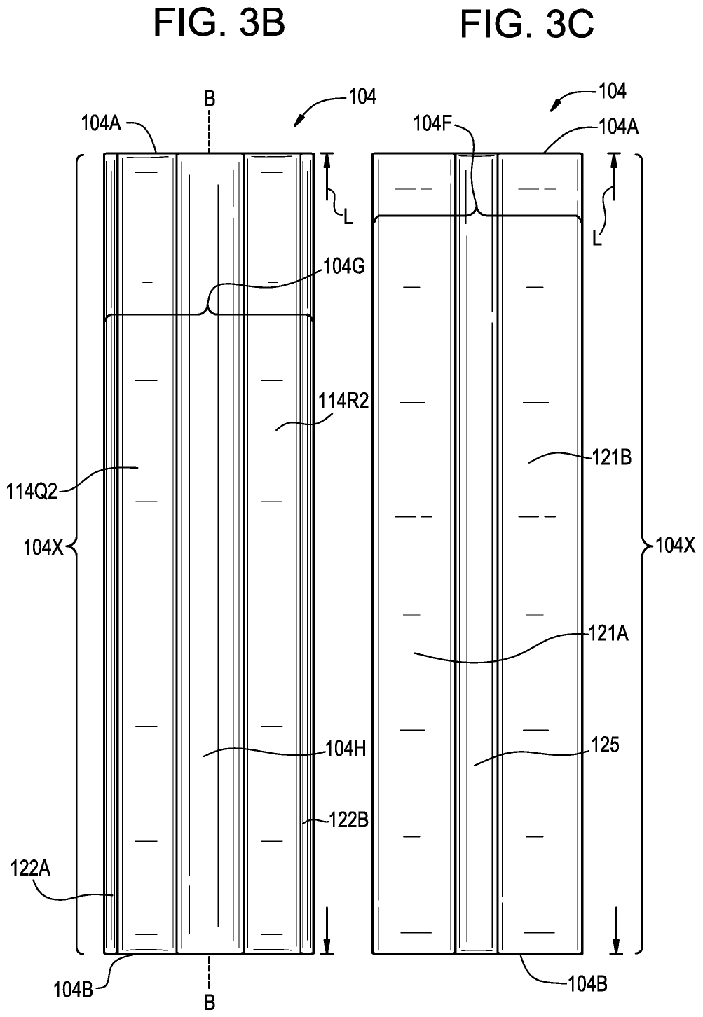

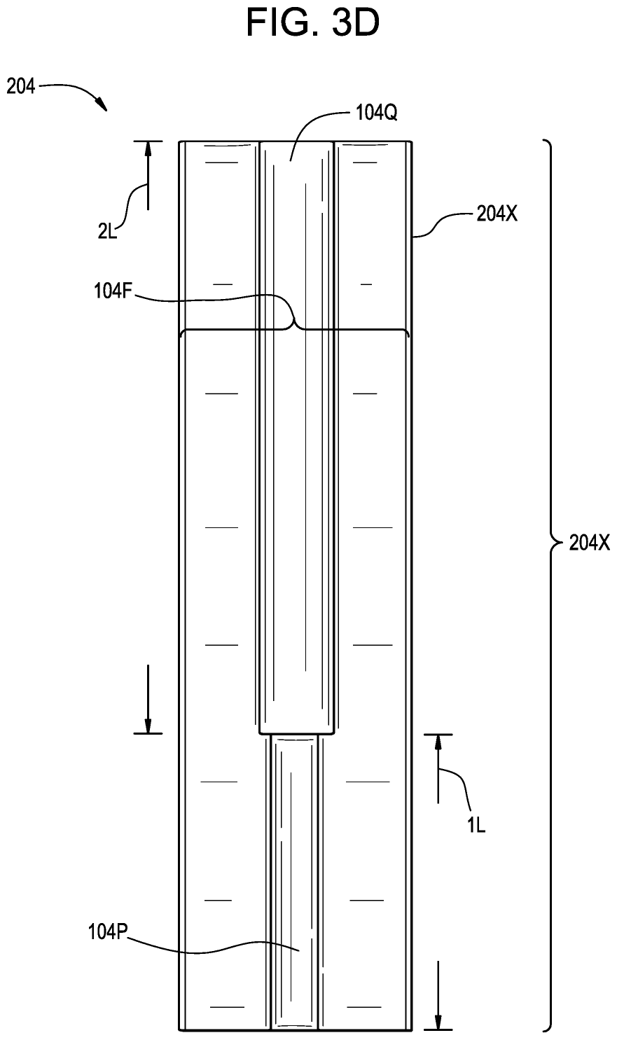

While the embodiment of FIG. 1A shows the connector 4 with two female ends, in other embodiments, the connector 4 has two male ends (not shown). In still other embodiments, the connector 4 has a male end and a female end. Such an embodiment is shown in FIG. 3A-3C. A connector 4 is provided for removably securing and vertically stacking perimeter components of the multi-stacked perimeter assembly 1000. The connector 4 includes an elongated body 104X extending a length L from a first axial end 104A to a second axial end 104B along an axis B thereof. The first anchoring feature 104Q and the second anchoring feature 104R are contained between the front face 104F1 and the back face 104F2. The first anchoring feature 104Q is configured to anchor an object (i.e., one or more perimeter components) at one side of the connector 104, and the second anchoring feature 104R is configured to anchor an object (i.e., one or more perimeter components) at an opposite side of the connector 104.

In various embodiments, the anchoring feature 104Q extends at least a portion of the length L along the first lateral side 104F of the elongated body 104X. In the embodiment of FIGS. 3B-C, the first anchoring feature 104Q extends the entire length L along the first lateral side 104F of the elongated body 104X. The second anchoring feature 104R extends at least a portion of the length L along the second lateral side 104G of the elongated body 104X and faces opposite to the first anchoring feature 104Q. In the embodiment shown in FIGS. 3B-C, the second anchoring feature 104R extends the entire length L along the second lateral side 104G of the elongated body 104X.

The elongated body 104X includes a front face 104F1 and a back face 104F2 that is substantially parallel to the front face 104F1. The anchoring feature 104 includes an arc 125. The arc 125 is formed with an opening facing towards the first lateral side 104F. The elongated body 104X is substantially hollow and comprises a gusset configuration 114 connecting the first anchoring feature 104Q to the second anchoring feature 104R. In this way, the front face 104F1 and the back face 104F2 are connected to one another by the gusset configuration 114. The gusset configuration 114 includes a structural ribs 114Q1 and 114R1 extending away from the arc 125 at oblique angles. The structural rib 114Q1 extends from the arc 125 towards the second lateral side 104G and into the exterior wall 123Q at junction 114Q. The structural rib 114R1 extends from the arc 125 towards the second lateral side 104G and into the exterior wall 123R at junction 114R.

The first anchoring feature 104Q includes a groove 104G1, and the second anchoring feature 4R comprises a protuberance 104P that is positioned opposite the groove 104G1. The interior wall 116A extends from an end of the arc 125, proximate the opening of the arc 125, and towards the first lateral side 104F. The interior wall 116B extends from another end of the arc 125, proximate the opening of the arc 125, and towards the first lateral side 104F. The first lateral side 104F includes two first shoulders 121A, 121B. The first shoulder 121A extends from an end of the interior wall 116A towards the front face 104F1. The second shoulder 121B extends from an end of the interior wall 116B and towards the back face 104F2. In some embodiments, the first anchoring feature 4Q is oriented 180 degrees from the second anchoring feature 4R. In some embodiments, the first anchoring feature 4Q is oriented 90 degrees from the second anchoring feature 4R.

The connector 104 further includes exterior walls 123Q and 123R. The exterior wall 123Q extends from the first shoulder 121A and towards the second lateral side 104G, to junction 114Q. The exterior wall 123R extends from the first shoulder 121B and towards the second lateral side 104G, to junction 114R. The second lateral side 104G includes two second shoulders 122A, 122B. The second shoulder 122A extends from the junction 114Q away from the first lateral side 104F. The second shoulder 122B extends from the junction 114R away from the first lateral side 104F.

The connector 104 further includes a protuberance 104P. The protuberance includes inward segments 114Q2, 114R2, opposing interior walls 118A, 118B, and a bulbous head 104H. The inward segment 114Q2 extends inwardly from the junction 114Q. The inward segment 114R2 extends inwardly from the junction 114R2. The interior wall 118A extends from the inward segment 114Q2 and away from the first lateral side 104F. The interior wall 118B extends from the inward segment 114R2 and away from the first lateral side 104F. The opposing interior walls 118A, 118B define a necked-in area 118N. The opposing interior walls 118A, 118B terminate in a bulbous head 104H. The first pair of opposing interior walls 116A, 116B defines a slot 116. The slot 116 extends inwardly from the first lateral side 104F towards the protuberance 104P, and the protuberance 104P extends outwardly away from the slot 116. The groove 104G1 includes a first area of increased cross-section 120Q that extends inwardly from the slot 116.

The first shoulders 121A, 121B are configured to abut and stabilize at least two first perimeter components 1A, 1B, and the two second shoulders 122A, 122B are configured to abut and stabilize at least two second perimeter components. Some perimeter components include a male component that is configured to mate with the first anchoring feature 104Q, which is female. Some perimeter components include a female component that is configured to mate with the second anchoring feature 104R, which is male. Although in the embodiment of FIG. 3A the connector 104 is hollow, in other embodiments, the connector 104 is solid. In a preferred embodiment, the connector 104 is made out of plastic. In other embodiments, the connector 4 is made out of metal or another suitable material.

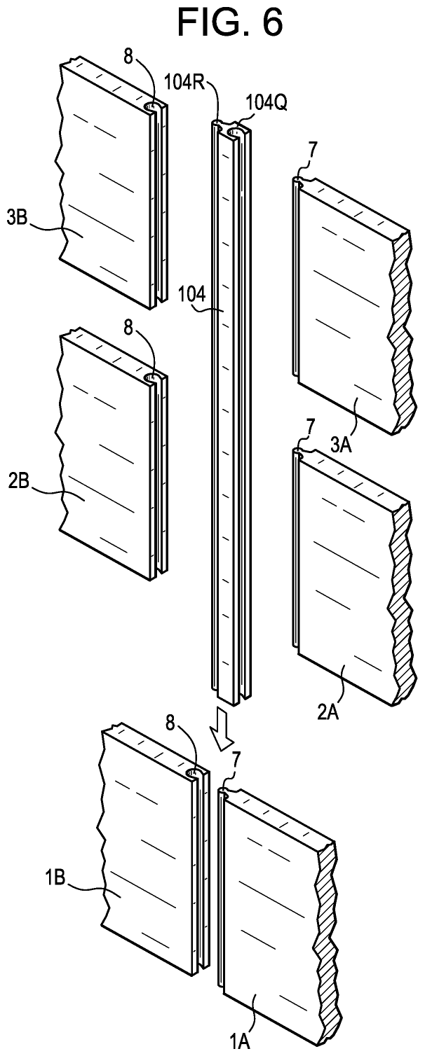

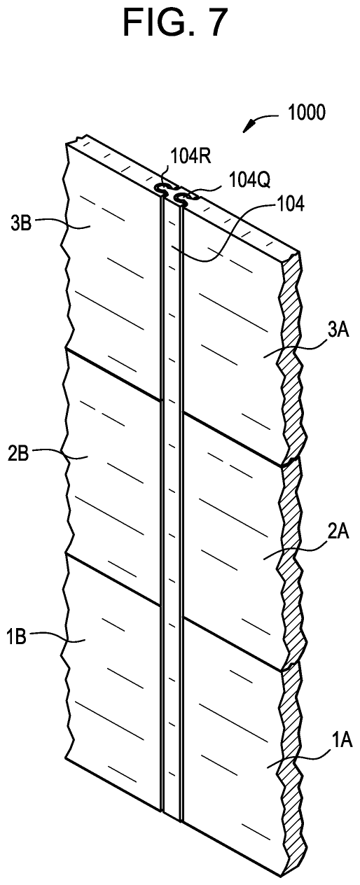

Referring to FIGS. 6-7, the assembly process is illustrated in more detail. A tab 7 of perimeter component 1A is slid into the first anchoring feature 104Q of the connector 104, and the second anchoring feature 104R is slid into a groove 8 of the perimeter component 1B. Similarly, a tab of the perimeter component 2A is slid into the first anchoring feature 104Q of the connector 104, and the second anchoring feature 104R is slid into a groove of the perimeter component 2B. Then, a tab 7 of the perimeter component 3A is slid into the first anchoring feature 104Q of the connector 104, and the second anchoring feature 104R is slid into a groove of the perimeter component 3B. Other perimeter components and connectors 104 of the multi-stacked perimeter assembly 1000 are assembled in the same manner. In the embodiment of FIGS. 6-7, the tab 7 is in the form of a protuberance. The shape of the tab 7 shape is complimentary shape to the first anchoring feature 4Q or the second anchoring feature 4R. In other embodiments, the tab 7 and the second anchoring features 4R and the first anchoring feature 4Q have other shapes.

In the assembly of FIGS. 4-5, the multi-stacked perimeter assembly 1000 includes the connector 4, a first pair of perimeter components 1A, 1B removably joined by the connector 4 and a second pair of perimeter components 2A, 2B stacked vertically on top of the first pair of perimeter components 1A, 1B and removably joined by the connector 4. A third pair of perimeter components 3A, 3B are stacked vertically on top of the second pair of perimeter components 2A, 2B and removably joined by the connector 104. In some embodiments, the length L of the connector 104 is at least two times a height of any of the first pair of perimeter components 1A, 1B, the second pair of perimeter components 2A, 2B and the third pair of perimeter components 3A, 3B. In the embodiment of FIGS. 6-7, the length L of the connector 4 is three times the height of the perimeter components 1A. In some embodiments, other perimeter components 1B, 1C, 2A, 2B, 2C are of the same dimension as the perimeter component 1A. In other embodiments, the dimensions are different.

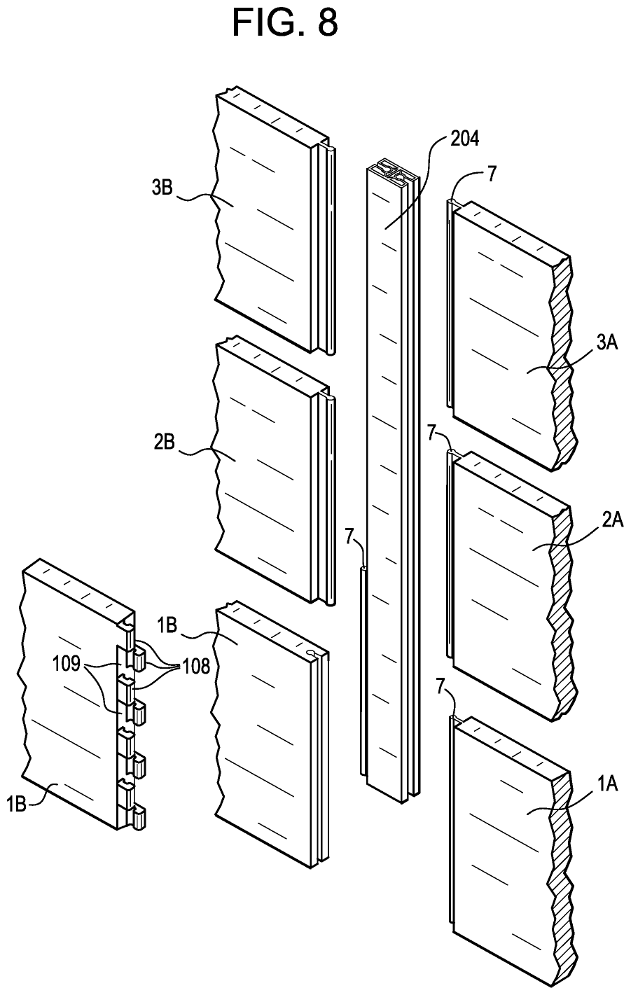

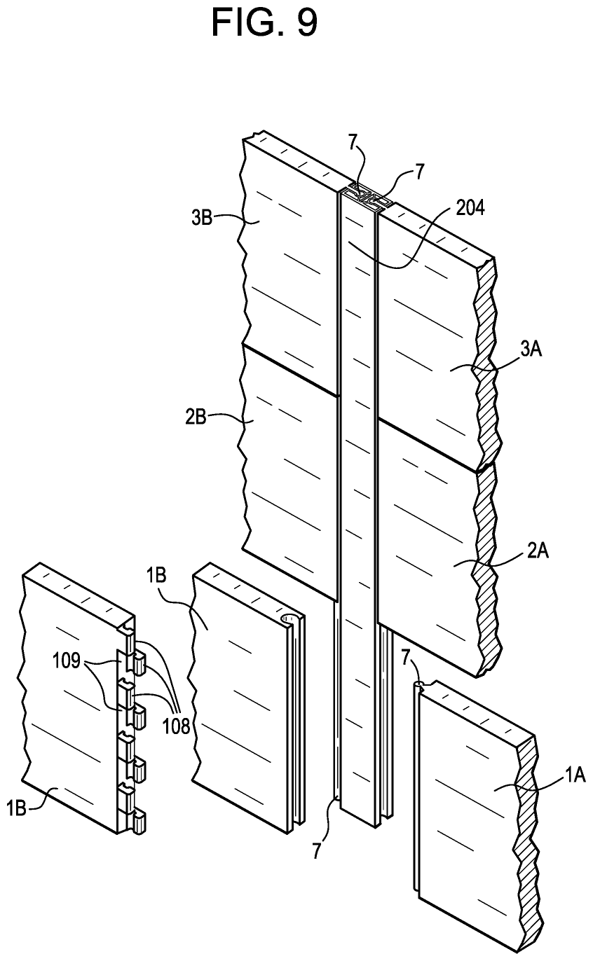

Referring to FIG. 3D and FIGS. 8-9 in some embodiments, the connector 4 has a side that is partially female with the remainder of the side being male. That is, in some embodiments, the first anchoring feature 104Q with the first groove 104G1 and the second anchoring feature 104R with the protuberance 104P extend along a first portion 1L of the elongated body 204X, another first groove 4G1 extends along a second portion 2L of the elongated body 204X on the first lateral side 104F, and a second groove 4G2 extends along the second portion 2L of the elongated body 204X on the second lateral side 104G. In some embodiments, the first portion 1L is equal to about one third of the length L of the elongated body 204X, and the second portion 2L is equal to about two thirds of the length L of the elongated body 204X. In some embodiments, the first groove 4G1 extends the entire length L along the first lateral side 4F. In some embodiments, the second groove 4G2 extends the entire length L along the second lateral side 4G.

In some embodiments, the perimeter component 1B has an alternate configuration. The perimeter component 1B with the alternate configuration includes staggered fingers 108 one side of the perimeter component 1B. The staggered fingers 108 are separated by gaps 109. The protuberance 7 of connector 204 interlocks (engages) with or slides into the fingers 8.

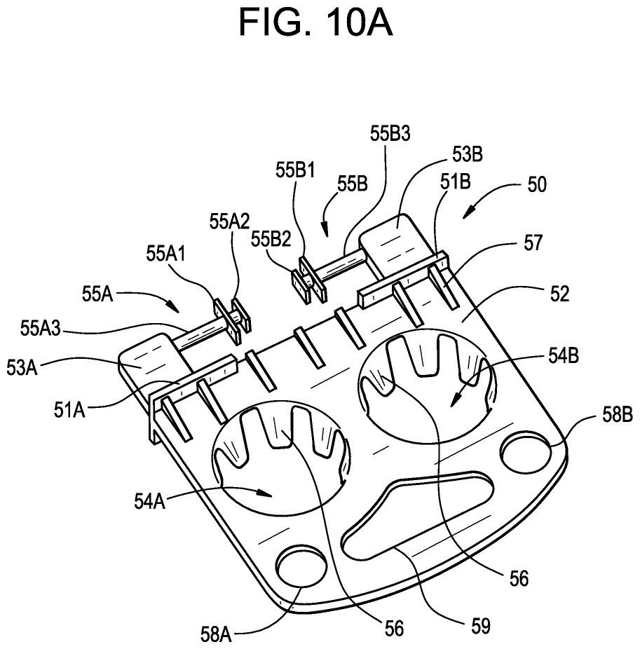

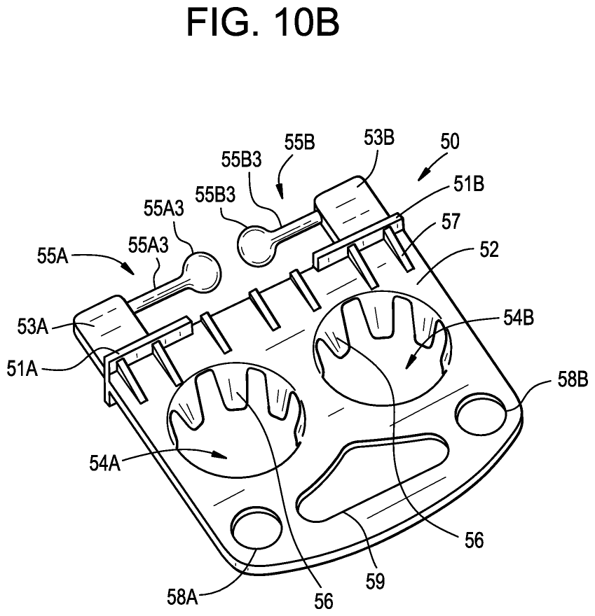

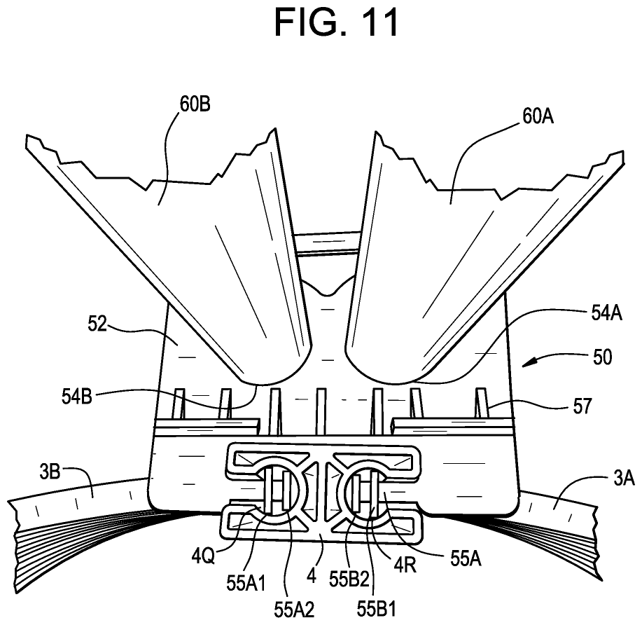

Referring to FIGS. 10A-12, the multi-stacked perimeter assembly 1000 further includes a pole support 50 removably joined to the connector 4. The pole support 50 is positioned horizontally between a first row of perimeter components 1A, 1B and a second row of perimeter components 2A, 2B. Another pole support 50 is positioned horizontally between a second row of the perimeter components 2A, 2B and a third row of perimeter components 3A, 3B. In some embodiments, another pole support 50 is positioned horizontally on top of a third row of perimeter components 3A, 3B (not shown). The pole support 50 includes walls 51A, 51B for abutting the perimeter components. Base extensions 53a, 53b extend from the base 50 proximate the walls 51A, 51B and are positioned between upper and lower rows of the perimeter components.

The pole support 50 includes a base 52 having apertures 54A, 54B extending therethrough. The apertures 54A, 54B includes a gripping feature 56 having radially inwardly biasing members. In some embodiments, the radially inwardly biasing members are flaps that help secure a pole 60A 60B that extends through the apertures. The pole support 50 also includes a plurality of ribs 57 for providing structural support to the base. Holes 58A, 58B and an opening 59 are formed in the base 52 to reduce the overall weight of the base 50. The opening 59 can also be used as a handle. In some embodiments, the assembly includes the connector 4, 104, 204, a first pair of first perimeter components 1A, 1B removably joined by the connector 4, 104, 204, and a second pair of second perimeter components 2A, 2B stacked vertically on top of the first pair of first perimeter components 1A, 1B and removably joined by the connector 4, 104, 204. In some embodiments, the multi-stacked perimeter assembly 1000 includes a third pair of perimeter components 3A, 3B stacked vertically on top of one of the second pair of perimeter components 2A, 2B and removably joined to the connector 4, 104, 204. In some embodiments, the multi-stacked perimeter assembly 1000 includes a third pair of third perimeter components 3A, 3B are stacked on top of the second pair of second perimeter components 2A, 2B and removably joined by the connector 4, 104, 204. The present invention according to an embodiment includes a multi-stacked perimeter assembly 1000 for a skating rink. The assembly includes the connector 4, 104, 204; a first pair of first perimeter components 1A, 1B removably joined by the connector 4, 104, 204; and at least one perimeter component 2A, 2B stacked vertically on top of one of the first pair of first perimeter components 1A, 1B and removably joined to the connector 4, 104, 204. In some embodiments, the pole support 50 includes a connector receiving aperture that has a contour configured to receive the connector 4, 104, 204.

The pole support 50 also includes fasteners 55A, 55B extending therefrom. The fasteners 55A, 55B are configured to removably engage a first anchoring feature 4Q, 104Q and a second anchoring feature 4R, 104R of the connector 4, 104. The fastener 55A includes flanges 55A1 and 55A2 that are configured to be secured to the grooves 4G1, 4G2, 104G1 of anchoring features 4Q, 4R, 104Q, 104R. The flanges 55A1, 55A2 are parallel to each other, spaced apart, and sized to conform to the anchoring feature 4R or 4Q. The flanges 55A1, 55A2 are formed on a rod 55A3, 55B3 that extends inwardly from the base extension 53A. Likewise, the fastener 55B includes flanges 55B1, 55B2 that are configured to be secured to the grooves 4G1, 4G2, 104G1 of the second anchoring feature 4R or the first anchoring feature 4Q. The flanges 55B1, 55B2 are parallel to each other, spaced apart, and sized to conform to the anchoring feature 4R or 4Q. The flanges 55B1, 55B2 are formed on a rod 55B that extends inwardly from the base extension 53B. In the alternative embodiment shown in FIG. 10B, the fastener 55A includes a bulbous head 55A3, and the fastener 55B includes a bulbous head 55B3. The bulbous heads 55A3 and 55B3 conform to the anchoring feature 4R or 4Q and are configured to be secured thereto. In still other embodiments, the fasteners 55A and 55B include beads, spheres, three or more flanges, or the like that are configured to be secured to the anchoring feature 4R or 4Q.

In some embodiments, the length L of the connector 4, 104, 204 is at least two times a height of any of the first pair of perimeter components 1A, 1B, the second pair of perimeter components 2A, 2B and the third pair of perimeter components 3A, 3B. In some embodiments, the multi-stacked perimeter assembly 1000 includes at least one pole support 50 removably joined to the connector 4, 104, 204. In some embodiments, the at least one pole support 50 is positioned horizontally between the first pair of first perimeter components 1A, 1B and the second pair of second perimeter components 2A, 2B. The first pair of first perimeter components 1A, 1B is a first row, and the second pair of second perimeter components 2A, 2B is a second row. In some embodiments, the at least one pole support 50 is positioned horizontally between the second pair of second of perimeter components 2A, 2B and a third pair of third perimeter components 3A, 3B, which is a third row.

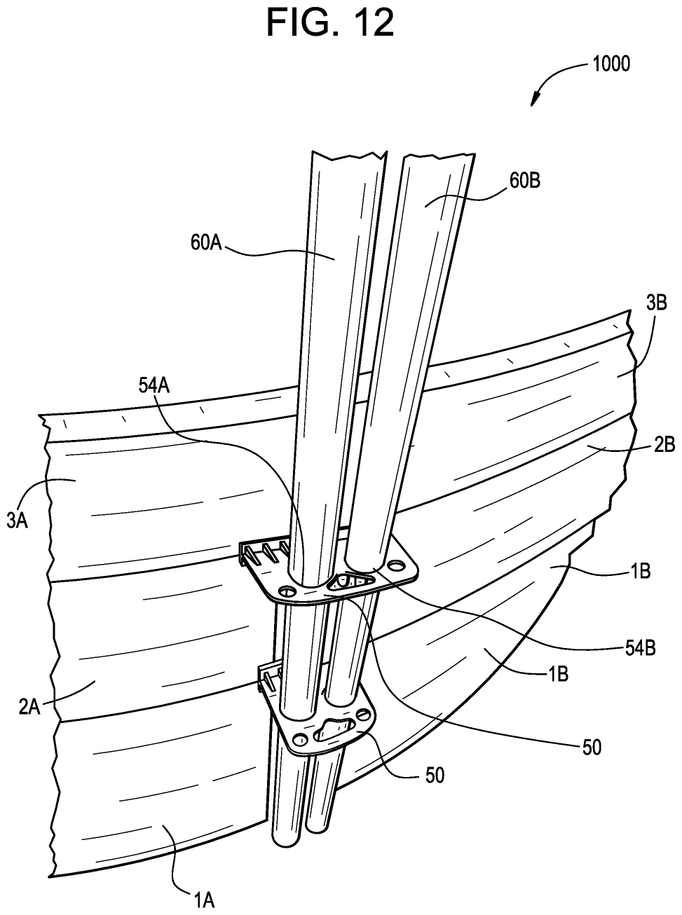

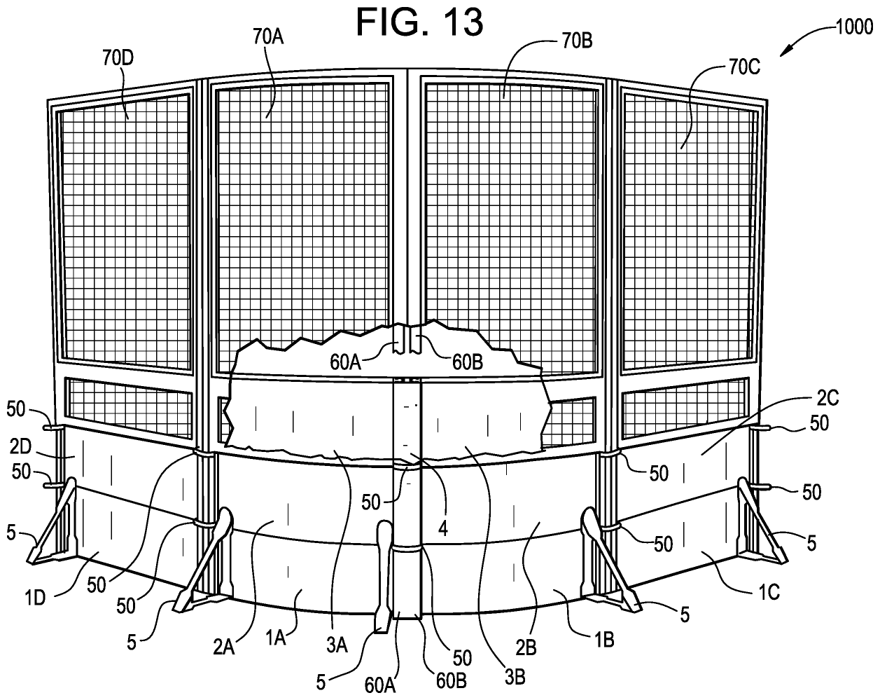

Referring to FIG. 13, a multi-stacked perimeter assembly 1000 according to an embodiment is provided. In some embodiments, the length L of the connector 4, 104, 204 is at least two times a height of any of the first pair of perimeter components 1A, 1B, the second pair of perimeter components 2A, 2B and the third pair of perimeter components 3A, 3B. In some embodiments, the at least one pole support 50 is positioned horizontally between the first pair of first perimeter components 1A, 1B and the second pair of second perimeter components 2A, 2B, the first pair of first perimeter components 1A, 1B is a first row, and the second pair of second perimeter components 2A, 2B is a second row. In some embodiments, the at least one pole support 50 is positioned horizontally between the second pair of second of perimeter components 2A, 2B and a third pair of third perimeter components 3A, 3B, which is a third row. Perimeter components 1A, 2A, and 3A are attached to the connector 4. Perimeter components 1B, 2B, and 3B are also attached to the connector 4 on an opposite side. A pole support 50 is attached to the connector 4 and disposed between row of perimeter components 1A and 1B and row of perimeter components 2A and 2b. Another pole support 50 is also attached to the connector 4 and disposed between row of perimeter components 2A and 2B and row of perimeter components 3A and 3B. Perimeter components 1C, 2C, 3C, 1D, 2D, and 3D are attached other connectors 4 (not visible in FIG. 13) such that the multi-stacked perimeter assembly 1000 is four perimeter components wide and three perimeter components high. Additional pole supports 50 are attached to other connectors 4 in the same manner as described above. The multi-stacked perimeter assembly 1000 further includes a pole 60A, 60B vertically and removably secured in each of the pole support 50. Holding member 5 are attached to the perimeter components 1A, 1B, 1C, and 1D on one or both sides of the perimeter components. The holding member 5 are shaped as triangles and are configured to prevent the perimeter component assembly 1000 from tipping over.

In some embodiments, the multi-stacked perimeter assembly 1000 further includes a containment barrier 70A, 70B, 70C, 70D removably coupled to at least one of the poles 60A, 60B. In the embodiment of FIG. 13, the containment barrier 70A, 70B, 70C, 70D includes a net system in which netting spans the gaps between adjacent poles 60A, 60B. The containment barrier 70A is disposed above perimeter components 1A, 2A, and 3A and covers at least part of perimeter component 3A. The containment barrier 70B is disposed above perimeter components 1B, 2B, and 3B and covers at least part of perimeter component 3B. The containment barrier 70C is disposed above perimeter components 1C, 2C, and 3C and covers at least part of perimeter component 3C. The containment barrier 70D is disposed above perimeter components 1D, 2D, and 3D and covers at least part of perimeter component 3D. In a preferred embodiment, the perimeter components 1 are made out of plastic, for example, a hollow molded panel with indentations for adding strength to the perimeter component. However, in other embodiments, the perimeter components are made out of metal or another suitable material.

In FIG. 13, the perimeter components are straight panels and are positioned to collectively form a curve. In some embodiments, one or more of the connectors 4 are curved to help form the overall curve shape of the stacked perimeter assembly 1000. In some embodiments, one or more of the perimeter components 1 are curved. In some embodiments, other areas of the stacked perimeter assembly 1000 are completely straight. In still other embodiments, areas (not shown) of the stacked perimeter assembly have irregular curves or sharp angles for covering an irregularly shaped ice skating rink.

The multi-stacked perimeter assembly 1000 thus serves as an effective barrier to prevent hockey pucks from being hit out of the rink. The multi-stacked perimeter assembly 1000 can even prevent a checked hockey player from being knocked out of the rink. Due to its modular construction, the multi-stacked perimeter assembly 1000 is easy to transport and assemble.

Referring to FIG. 14, a multi-stacked perimeter assembly 1000 is provided that completely encircles an ice-skating rink R. The perimeter components 1F, 1G, 1H, 1I, 1J, 1K, 1L, and 1M are arranged in a row with connectors 4 connecting ends of the perimeter components 1F, 1G, 1H, 1I, 1J, 1K, 1L, and 1M. An identical arrangement is disposed on the opposite side of the ice-skating rink R. Perimeter component 1F is jointed to perimeter component 1E by a connector 4. The connector 4 is sized to accommodate two perimeter components 1E and 2E. Perimeter component 2E is stacked vertically on top of perimeter component 1E and also attached to the connector 4. Perimeter component 2C is stacked vertically on top of perimeter component 1C. Perimeter components 1E and 2E are connected to one side of the connector 4, and perimeter components 1C and 2C are connected to the other side of the connector 4. Another perimeter component (not visible) is stacked vertically on top of perimeter 2C and is also connected to the connector 4. Perimeter component 1B is connected to an opposite side of the connector 4 that connects the perimeter component 1C. Another perimeter component 2B is stacked vertically on top of perimeter component 1B and is connected to the connector 4. Another perimeter component (not shown) is stacked vertically on top of the perimeter component 1B and connected to the connector 4.

The holding members 5 are disposed on or near each connector 4. The holding members 5 help stabilize the perimeter components to prevent them from tipping over. Pole supports 50 are engaged with the connector 4 and are disposed in a generally horizontal plane between the first row of perimeter components 1C and 1E and the second row of perimeter components 2C and 2E; between the second row of perimeter components 2C and 2E and the third row of perimeter components 3C and 3E and in similar places. Each pole support 50 secures at least one pole 60A, 60B. A containment barrier 70C is disposed over perimeter components 1C and 2C. The pole 60B is inserted into a first pocket of the containment barrier 70C, and another pole 60A is inserted into a second pocket of the containment barrier 70C. The containment barrier 70C has netting that spans between the poles 60A and 60B. Another containment barrier 70B is disposed above perimeter component 1B and 2B. The pole 60B is inserted into a first pocket of the containment barrier 70B, and a second pole 60A is inserted into a second pocket of the containment barrier 70B. The containment barrier 70B has netting that spans between the poles 60A and 60B. The netting can prevent a puck from being hit out of the rink R. It can even help prevent a checked skater from being thrown out of the rink R.

In the embodiment of FIG. 14, the multi-stacked perimeter assembly 1000 is assembled in a symmetrical manner. That is, additional perimeter components are installed on an opposite side of the ring R as perimeter components 1E, 2E, 1F, 1G, 1H, 1I, 1J, 1K, 1L, 1M, 1N, and 2N in the same configuration. Containment barriers 70C, 70B, 70A, 70B, 70A, 70B, and 70C on the far side in the view of FIG. 14 are installed on the near side in the view of FIG. 14 in the same configuration. Thus, the elements of the multi-stacked perimeter assembly 1000 completely surrounds the rink R.

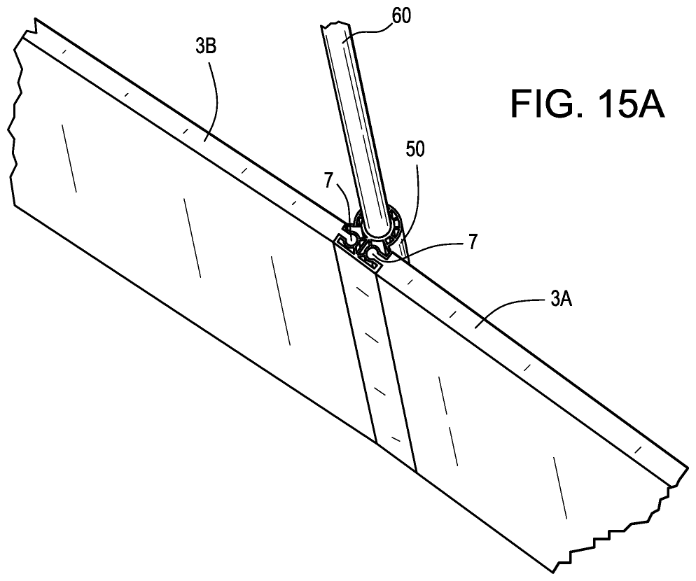

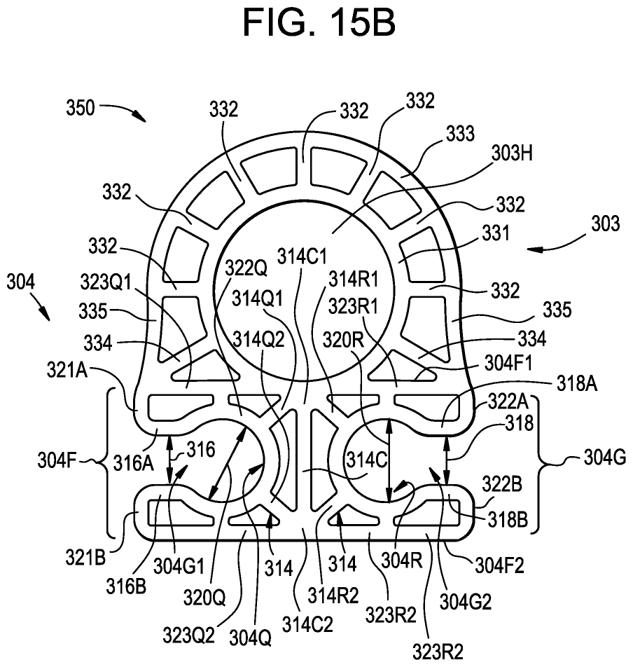

Referring to FIGS. 15A and 15B the pole support 50 is integrally formed with the connector 4, 104, 204 and extends along a width of the connector 4, 104, 204. The pole support 50 includes a connector portion 304 having substantially the same configuration as FIG. 1A. The reference numerals assigned to the connector portion 304 are the same as that as in in FIG. 1A but preceded by a “3”. In some embodiments, and as shown in FIG. 15B, the arc 322Q contacts or is directly connected to the exterior walls 323Q1, 323Q2, and the arc 322R contacts or is directly connected to exterior walls 323R1, 323R2. The pole support portion 330 includes an inner circle 331 that is tangential to the end 14C1 of the center rib 14C, and an outer semicircle 333 concentric with the inner circle. The inner circle 331 defines a hole 303H. Radial ribs 332 extend from the inner circle 331 and into the outer semicircle 333. Connector walls 335 extend from each end of the outer semicircle 333 and into the shoulders 321A, 322A, perpendicular to the shoulders 321A, 322A. Corner rib 334 extend from the inner circle 331 to the junction where the connector wall 335 meets the shoulder 321A, and corner rib 334 extends from the inner circle 331 to the junction where the connector wall 335 meets the shoulder 322A.

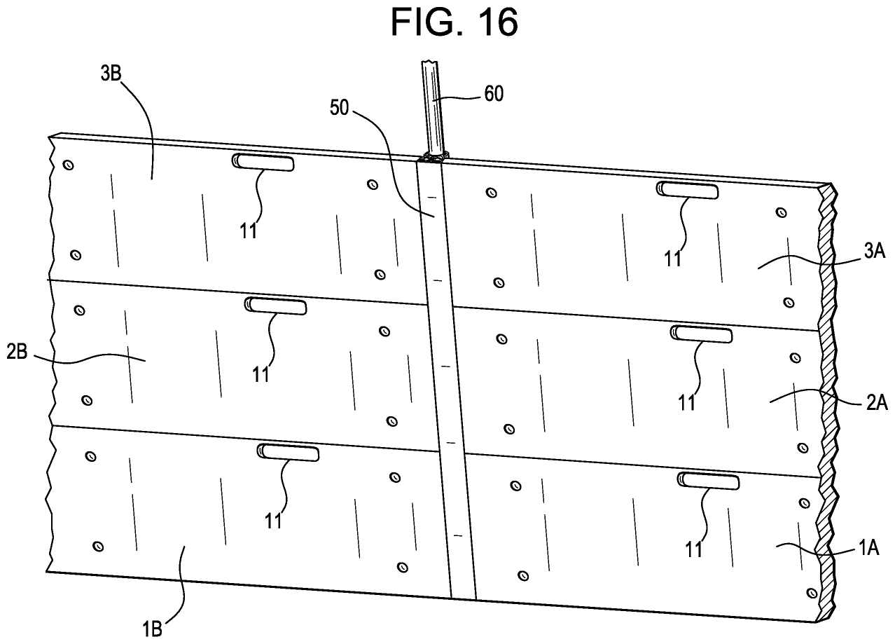

Referring to FIGS. 15A and 16, perimeter component 1A, 2A, and 3A are attached to the pole support 50 on one side and perimeter components 1B, 2B, and 3B are attached to the pole support 50 on the other side. That is, the tab 7 of perimeter component 1A, the tab 7 of perimeter component 2A, and the tab 7 of perimeter component 3A are inserted into the anchoring feature 4Q of the pole support 50; and the tab 7 of the perimeter component 1B, the tab 7 of the perimeter component 2B, and the tab 7 of the perimeter component 3B are inserted into the anchoring feature 4R. A pole 60 is inserted into the hole 303H defined by the inner circle 331 of the pole member 50. In the embodiment of FIG. 16, each of the perimeter components 1A, 2A, 3A, 1B, 2B, 3B has a handle 11.

Referring to FIG. 17, a multi-stacked perimeter assembly 1000 for a skating rink, according to an embodiment, is provided. The assembly includes a connector 4. In various embodiments, the connector 4 has the same configuration as any of the connectors 4,104, 204 described in this disclosure. A first perimeter component 1A1 having a first width W1 is removably attached to a first side 4A1 of the first connector 4A. A second perimeter component 1B2 having a second width W2 is removably attached to a second side 4A2 of the first connector 4A. The first width W1 is greater than the second width W.

The multi-stacked perimeter assembly 1000 shown in FIG. 17 further includes a second connector 4B. In various embodiments, the second connector 4B has the same configuration of any of the connectors 4, 104, 204 described in this disclosure. The second perimeter component 1B2 is removably attached to a first side 4B1 of the second connector 4B. A third perimeter component 1B′3 having a third width W3 is removably attached to a second side 4B2 of the second connector 4B.

Referring to FIG. 17, a fourth perimeter component 2A4 having the first width W1 is removably attached to the first side 4A1 of the first connector 4A and stacked vertically on top of the first perimeter component 1A1. A fifth perimeter component 2B5 having the second width W2 is removably attached to the second side 4A2 of the first connector 4A, removably attached to the first side 4B1 of the second connector 4A and stacked vertically on top of the second perimeter component 1B2. A sixth perimeter component 2B′6 having the third width W3 and is removably attached to the second side 4B2 of the second connector 4A and stacked vertically on top of the third perimeter component 1B′3. A seventh perimeter component 3A7 having the first width W1 is removably attached to the first side of the first connector 4A and stacked vertically on top of the fourth perimeter component 2A4. An eighth perimeter component 3B8 having a fourth width W4 is removably attached to the second side 4B2 of the first connector 4A and stacked vertically on top of the fifth perimeter component 2B5, the second connector 4B, and the sixth perimeter component 2B′6. The fourth width W4 is equal to a sum of the second width W2, a width of the second connector 4B, and the third width W3.

As shown in FIG. 17, in some embodiments, the first perimeter component 1A1, the second perimeter component 1B2, and the third perimeter component 1B′3 have the same height. In some embodiments, the fourth perimeter component 2A4, the fifth perimeter component 2B5, and the sixth perimeter component LB′6 have the same height. In some embodiments, the seventh perimeter component 3A7 and the eighth perimeter component 3B8 have the same height. In some embodiments, all of the perimeter components 1A1, 1B2, 1B′3, 2A4, 2B5, LB′6, 3A7, 3B8 have the same height.

Referring to FIG. 18A, a multi-stacked perimeter assembly 1000 for a skating rink, according to an embodiment, is provided. The assembly 1000 includes the connector 4, 104, 204. In various embodiments, the connector 4 has the same configuration as any of the connectors 4,104, 204 described in this disclosure. A first perimeter component 1B1 having a first height H1 is removably attached to a first side 4S1 of the connector 4. A second perimeter component 1A2 having a second height H2 is removably attached to a second side 4S2 of the connector 4. The first height H1 is less than the second height H2.

As shown in FIG. 18A, the multi-stacked perimeter assembly 1000 further includes a third perimeter component 2B3 having a third height H3, removably attached to the first side 4S1 of the connector 4 and stacked vertically on top of the first perimeter component 1B1. A sum of the first height H1 and the third height H3 is greater than the first height H1. A fourth perimeter component 2A4 having a fourth height H4 is removably attached to the second side 4S2 of the connector 4 and stacked vertically on top of the second perimeter component 1A2. The sum of the first height H1 and the third height H3 is less than a sum of the second height H2 and the fourth height H4.

As shown in FIG. 18A, a fifth perimeter component (3B5) having a fifth height (H5) is removably attached to the first side (4S1) of the connector (4) and stacked vertically on top of the third perimeter component (2B3). A sum of the first height (H1), the third height (H3), and the fifth height (H5) is greater than the sum of the second height (H2) and the fourth height (H4). A sixth perimeter component (3A6) having a sixth height (H6) is removably attached to the second side (4S2) of the connector (4) and stacked vertically on top of the fourth perimeter component (H54). The sum of the first height (H1), the third height (H3), and the fifth height (H5) is equal to a sum of the second height (H2), the fourth height (H4), and the sixth height (H6) and is equal to a height of the connector (4).

As shown in FIG. 18A, in some embodiments, none of the perimeter components 1B1, 1A2, 2B3, 2A4, 3B5, and 3A6 have the same height. In some embodiments, the first perimeter component 1B1, the second perimeter component 2B3, and the third perimeter component 3B5 have the same width. In some embodiments, the second perimeter component 1A2, the fourth perimeter component 2A4, and the third perimeter component 3A6 have the same width.

Referring to FIG. 18B, a multi-stacked perimeter assembly 1000) for a skating rink, according to an embodiment, is provided. The assembly 1000 includes a first perimeter component 1B1 having a first height H1; a second perimeter component 1A2 having a second height H2 and removably attached to the first perimeter component 1B1; and a third perimeter component 2B3 having a third height H3 and removably attached to the second perimeter component 1A2 and stacked vertically on top of the first perimeter component 1B1. A sum of the first height H1 and the third height H3 is greater than the second height H2.

As shown in FIG. 18B, a fourth perimeter component 2A4 having a fourth height H4 is removably attached to the third perimeter component 2B3 and stacked vertically on top of the second perimeter component 1A2. The sum of the first height H1 and the third height H3 is less than a sum of the second height H2 and the fourth height H4.

As shown in FIG. 18B, a fifth perimeter component 3B5 having a fifth height H5 is removably attached to the fourth perimeter component 2A2 and stacked vertically on top of the third perimeter component 2B3. A sum of the first height H1), the third height H3, and the fifth height H5 is greater than a sum of the second height H2 and the fourth height H4. A sixth perimeter component 3A6 having a sixth height H6 is removably attached to the fifth perimeter component H5 and stacked vertically on top of the fourth perimeter component 2A4. The sum of the first height H1, the third height H3, and the fifth height H5 is equal to a sum of the second height H2, the fourth height H4, and the sixth height H6.

As shown in FIG. 18B, in some embodiments, the attachment of the second perimeter component 1A2 to the first perimeter component 1B1 and the attachment of the attachment of the third perimeter component 2B3 to the second perimeter component 1A2 vertically stabilizes the third perimeter component 2B3. In some embodiments, the attachment of the third perimeter component 2B3 to the second perimeter component 1A2 and the attachment of the fourth perimeter component 2A4 to the third perimeter component 2B3 vertically stabilizes the fourth perimeter component 2A4. In some embodiments, the attachment of the fourth perimeter component 2A4 to the third perimeter component 2B3 and the attachment of the fifth perimeter component 3A6 to the fourth perimeter component 2A4 vertically stabilizes the fifth perimeter component 3A6. In some embodiments, the attachment of the fifth perimeter component 3B5 to the fourth perimeter component 2A4 and the attachment of the sixth perimeter component 3A6 to the fifth perimeter component 3B5 vertically stabilizes the sixth perimeter component 3A6.

As shown in FIG. 18B, in some embodiments, the first perimeter component 1B1, the third perimeter component 2B3, and the fifth perimeter component 3B5 each have a tab 7, and the second perimeter component 1A2, the fourth perimeter component 2A4, and the sixth perimeter component 3A6 each have a groove 8, wherein the tabs 7 are inserted into the grooves 8. In other embodiments, the first perimeter component 1B1, the third perimeter component 2B3, and the fifth perimeter component 3B5 each have a groove 8, and the second perimeter component 1A2, the fourth perimeter component 2A4, and the sixth perimeter component 3A6 each have a tab 7, wherein the tabs 7 are inserted into the grooves 8.

As shown in FIG. 18B, in some embodiments, none of the perimeter components 1B1, 1A2, 2B3, 2A4, 3B5, and 3A6 have the same height. In some embodiments, the first perimeter component 1B1, the second perimeter component 2B3, and the third perimeter component 3B5 have the same width. In some embodiments, the second perimeter component 1A2, the fourth perimeter component 2A4, and the third perimeter component 3A6 have the same width.

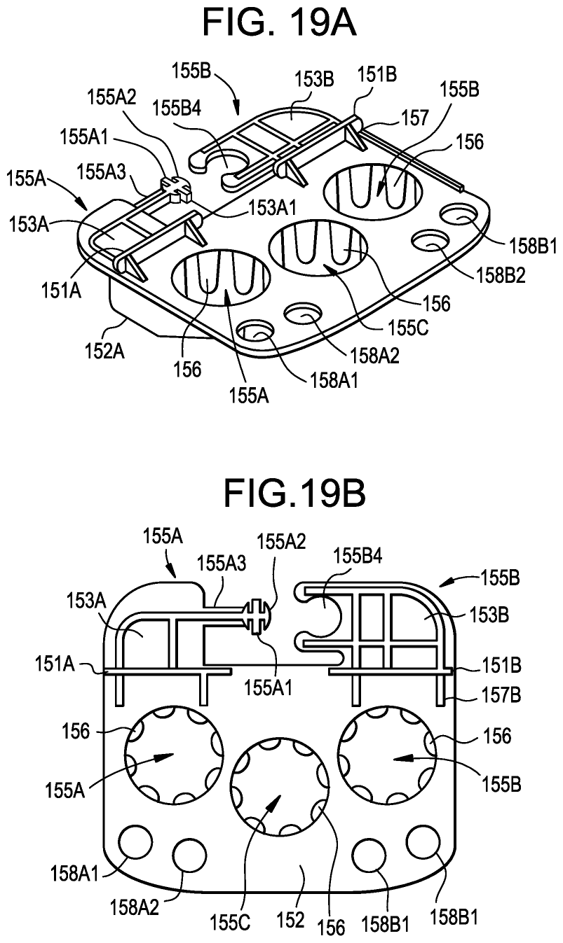

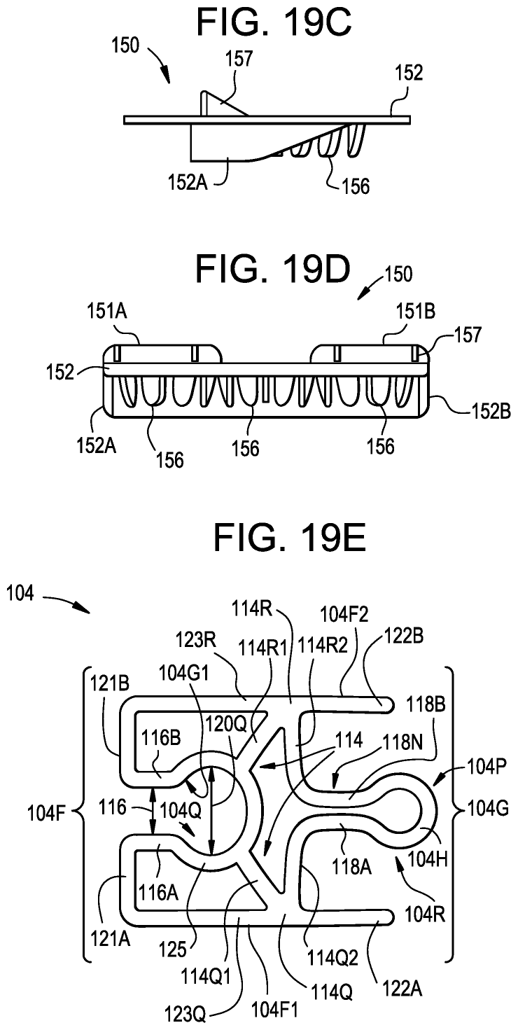

Referring to FIGS. 19A-19E, another embodiment of the pole support 50 is provided. The pole support 5 of FIGS. 19A-19E has a similar configuration as the embodiment of FIG. 10A, with some differences including three apertures 156 and has fasteners 155A, 155B configured to mate with the connector 104 of FIG. 3A through 3C.

In some embodiments, the pole support is configured to position a first pair of poles in a first plane and to position a second pair of poles in a second plane that is oriented at an angle relative to the first plane, the angle being less than 180 degrees.

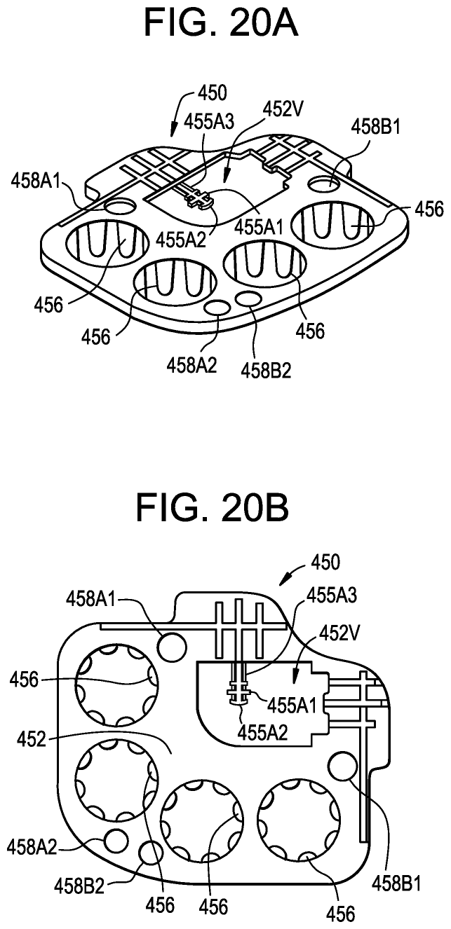

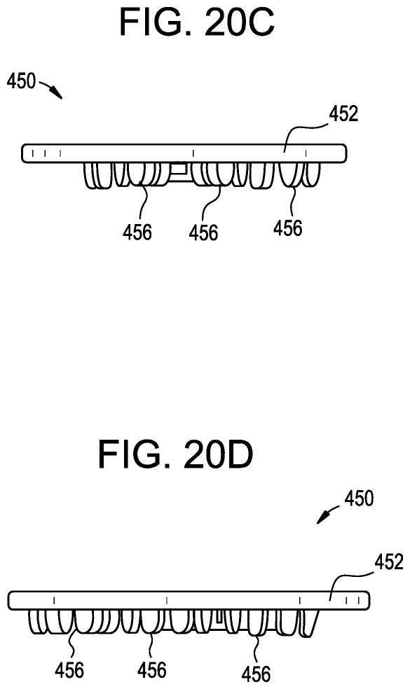

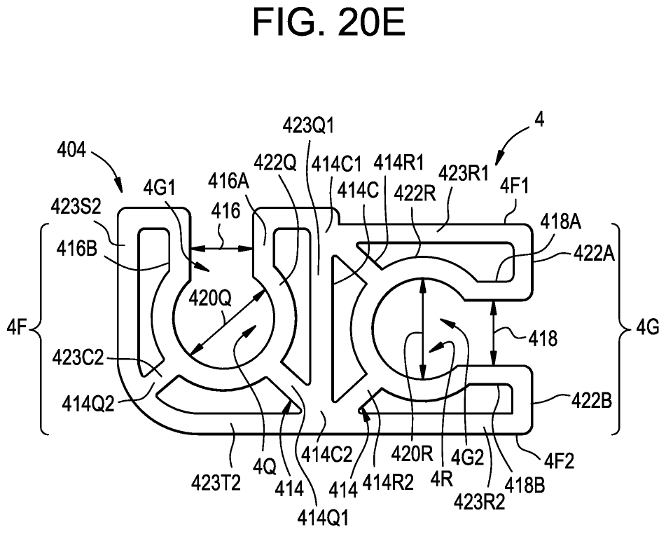

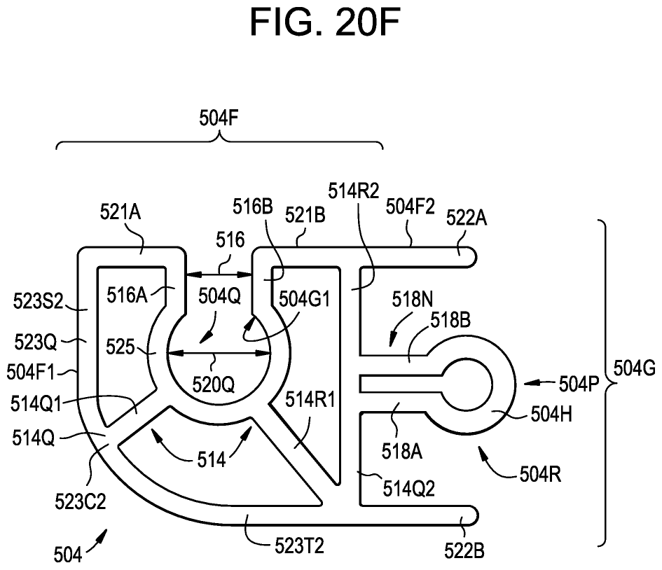

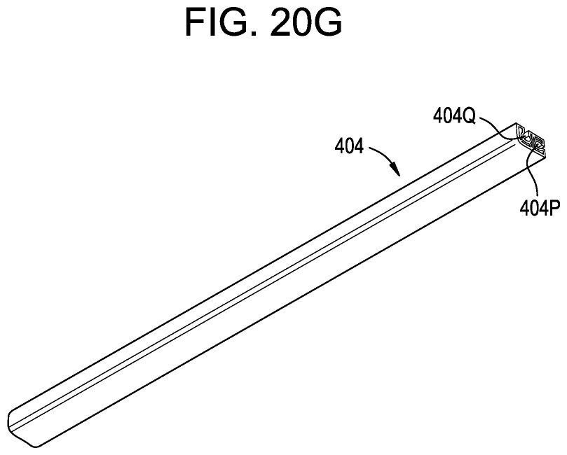

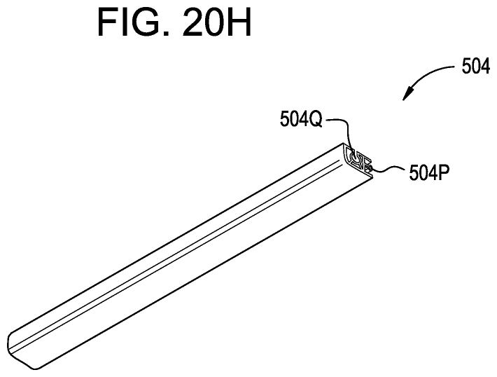

FIGS. 20A-20H In some embodiments, the pole support is configured to position a first pair of poles in a first plane and to position a second pair of poles in a second plane that is oriented at an angle relative to the first plane, the angle being less than 180 degrees, for example 90 degrees. The present invention according to an embodiment includes a pole support 50 for receiving at least one pole. The pole support 50 includes a base 52 having an aperture 54A, 54B formed therein; and a fastener 55A, 55B extending inwardly from a perimeter of the aperture. The pole support is configured to interchangeably mate with a first one of the connector and a second one of the connector. The first anchoring feature of the first connector is oriented perpendicular to the second anchoring feature of the first connector. The first anchoring feature of the second connector is oriented perpendicular to the second anchoring feature of the second connector. The mating of the pole support with the first connector includes the first connector extending through the aperture and the first anchoring feature of the first connector being fastened to the fastener. The mating of the pole support with the second connector includes the second connector extending through the aperture and the first anchoring feature of the second connector being fastened to the fastener.

In some embodiments, the fastener is male, the first anchoring feature of the first connector is female, and the first anchoring feature of the second connector is female. In some embodiments, the second anchoring feature of the first connector is female, and the second anchoring feature of the second connector is male. In some embodiments, the fastener includes a flange. In some embodiments, the first anchoring feature of the first connector includes a first groove, the second anchoring feature of the first connector includes a second groove, the first anchoring feature of the second connector includes a third groove, and the second anchoring feature of the second connector includes a protuberance. In some embodiments, the aperture being configured to interchangeably mate with the first connector and the second connector enables mating of the aperture with the first connector at a first time and mating of the aperture with the second connector at a second time. In some embodiments, a cross sectional area of the aperture is smaller than a sum of a cross sectional area of the first connector and a cross sectional area of the second connector.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A connector for removably securing and vertically stacking perimeter components of a skating rink, the connector comprising:
an elongated body extending a length from a first axial end to a second axial end along an axis thereof, the length being selected to span a height of at least two perimeter components;
a first anchoring feature extending at least a portion of the length into or along a first lateral side of the elongated body; and
a second anchoring feature extending at least a portion of the length into or along a second lateral side of the elongated body.

2. The connector of claim 1, wherein the first anchoring feature comprises a first groove, and the second anchoring feature comprises a second groove.

3. The connector of claim 2, wherein the first groove comprises a first slot defined by a first pair of opposing interior walls, and the second groove comprises a second slot defined by a second pair of opposing interior walls, wherein the first slot extends inwardly from the first lateral side towards the second slot, and the second slot extends inwardly from the second lateral side towards the first slot.

4. The connector of claim 3, wherein the first groove comprises a first area of increased cross-section that extends inwardly from the first slot, and the second groove comprises a second area of increased cross-section that extends inwardly from the second slot.

5. The connector of claim 1, wherein the first anchoring feature is a mirror image of the second anchoring feature.

6. The connector of claim 1, wherein the first anchoring feature is oriented 180 degrees from the second anchoring feature.

7. The connector of claim 1, wherein the first anchoring feature is oriented 90 degrees from the second anchoring feature.

8. The connector of claim 1, wherein the elongated body is substantially hollow and comprises a gusset configuration connecting the first anchoring feature to the second anchoring feature.

9. The connector of claim 1, wherein the elongated body comprises a front face and a back face that is substantially parallel to the front face.

10. The connector of claim 9, wherein the front face and the back face are connected to one another by a gusset configuration.

11. The connector of claim 10, wherein the first anchoring feature and the second anchoring feature are contained between the front face and the back face.

12. The connector of claim 1, wherein the first lateral side comprises two first shoulders, and the second lateral side comprises two second shoulders, wherein the two first shoulders are configured to abut and stabilize at least two first perimeter components, and the two second shoulders are configured to abut and stabilize at least two second perimeter components.

13. The connector of claim 1, wherein the first anchoring feature comprises a first groove, and the second anchoring feature comprises a protuberance.

14. The connector of claim 13, wherein the first anchoring feature is oriented 180 degrees from the second anchoring feature.

15. The connector of claim 13, wherein the first anchoring feature is oriented 90 degrees from the second anchoring feature.

16. The connector of claim 13, wherein the first groove comprises a slot defined by a first pair of opposing interior walls, and the protuberance comprises a necked-in area defined by a second pair of opposing interior walls that terminate in a bulbous head, wherein the slot extends inwardly from the first lateral side towards the protuberance, and the protuberance extends outwardly away from the slot.

17. The connector of claim 16, wherein the first groove comprises a first area of increased cross-section that extends inwardly from the slot.

18. The connector of claim 13, wherein
the first anchoring feature with the first groove and the second anchoring feature with the protuberance extend along a first portion of the elongated body,
another first groove extends along a second portion of the elongated body on the first lateral side, and
a second groove extends along the second portion of the elongated body on the second lateral side.

19. The connector of claim 18, wherein the first portion is equal to about one third of the length of the elongated body, and the second portion is equal to about two thirds of the length of the elongated body.

20. The connector of claim 2, wherein the first groove extends the entire length along the first lateral side.

21. The connector of claim 2, wherein the second groove extends the entire length along the second lateral side.

22. A pole support for receiving at least one pole, the pole support comprising:
a base having at least one aperture extending therethrough; and
at least one fastener extending therefrom;
wherein the at least one fastener is configured to removably engage the first anchoring feature and the second anchoring feature of the connector of claim 1.

23. The pole support of claim 22, wherein the at least one fastener comprises a gripping feature having radially inwardly biasing members.

24. A multi-stacked perimeter assembly for a skating rink, the assembly comprising:
the connector of claim 1;
a first pair of first perimeter components removably joined by the connector; and
a second pair of second perimeter components stacked vertically on top of the first pair of first perimeter components and removably joined by the connector.

25. The multi-stacked perimeter assembly of claim 24, further comprising:
a third pair of third perimeter components stacked vertically on top of the second pair of second perimeter components and removably joined by the connector.

26. The multi-stacked perimeter assembly of claim 24, further comprising:
a third perimeter component stacked vertically on top of one of the second pair of perimeter components and removably joined to the connector.

27. A multi-stacked perimeter assembly for a skating rink, the assembly comprising:
the connector of claim 1;
a first pair of first perimeter components removably joined by the connector, and
at least one perimeter component stacked vertically on top of one of the first pair of first perimeter components and removably joined to the connector.

28. The pole support of claim 22, wherein the pole support comprises a connector receiving aperture that has a contour configured to receive the connector of claim 2.

29. A pole support for receiving at least one pole, the pole support comprising:
a base having an aperture formed therein; and
a fastener extending inwardly from a perimeter of the aperture;
wherein the pole support is configured to interchangeably mate with a first one of the connector of claim 1 and a second one of the connector of claim 1,
wherein the first anchoring feature of the first connector is oriented perpendicular to the second anchoring feature of the first connector,
wherein the first anchoring feature of the second connector is oriented perpendicular to the second anchoring feature of the second connector,
wherein the mating of the pole support with the first connector comprises the first connector extending through the aperture and the first anchoring feature of the first connector being fastened to the fastener, and
wherein the mating of the pole support with the second connector comprises the second connector extending through the aperture and the first anchoring feature of the second connector being fastened to the fastener.

30. The pole support of claim 29, wherein the fastener is male, the first anchoring feature of the first connector is female, and the first anchoring feature of the second connector is female.

31. The pole support of claim 30, wherein the second anchoring feature of the first connector is female, and the second anchoring feature of the second connector is male.

32. The pole support of claim 29, wherein the fastener comprises a flange.

33. The pole support of claim 29, wherein the first anchoring feature of the first connector comprises a first groove, the second anchoring feature of the first connector comprises a second groove, the first anchoring feature of the second connector comprises a third groove, and the second anchoring feature of the second connector comprises a protuberance.

34. The pole support of claim 29, wherein the aperture being configured to interchangeably mate with the first connector and the second connector enables mating of the aperture with the first connector at a first time and mating of the aperture with the second connector at a second time.

35. The pole support of claim 29, wherein a cross sectional area of the aperture is smaller than a sum of a cross sectional area of the first connector and a cross sectional area of the second connector.

36. The pole support of claim 22, wherein the pole support is configured to position a first pair of poles in a first plane and to position a second pair of poles in a second plane that is oriented at an angle relative to the first plane, the angle being less than 180 degrees.

37. The multi-stacked perimeter assembly of claim 24, wherein the length of the connector is at least two times a height of any of the first pair of perimeter components, the second pair of perimeter components and the third pair of perimeter components.

38. The multi-stacked perimeter assembly of claim 24, further comprising:
at least one pole support removably joined to the connector.

39. The multi-stacked perimeter assembly of claim 38, wherein
the at least one pole support is positioned horizontally between the first pair of first perimeter components perimeter component and the second pair of second perimeter components, perimeter component
the first pair of first perimeter components is a first row, and
the second pair of second perimeter components is a second row.

40. The multi-stacked perimeter assembly of claim 39, wherein the at least one pole support is positioned horizontally between the second pair of second of perimeter components and a third pair of third perimeter components, which is a third row perimeter component.

41. The multi-stacked perimeter assembly of claim 38, wherein the pole support is integrally formed with the connector.

42. The multi-stacked perimeter assembly of claim 38, wherein the pole support extends along a width of the connector.

43. The multi-stacked perimeter assembly of claim 38, further comprising:
at least one pole vertically and removably secured in the pole support.

44. The multi-stacked perimeter assembly of claim 43, further comprising a containment barrier removably coupled to the pole.

45. The multi-stacked perimeter assembly of claim 44, wherein the containment barrier comprises a net system.

46. A multi-stacked perimeter assembly for a skating rink, the assembly comprising:
a first one of the connector of claim 1;
a first perimeter component having a first width and being configured to be removably attached to a first side of the first connector; and
a second perimeter component having a second width and being configured to be removably attached to a second side of the first connector,
wherein the first width is greater than the second width.

47. The multi-stacked perimeter assembly of claim 46, further comprising a second one of the connector of claim 1, wherein the second perimeter component is further configured to be removably attached to a first side of the second connector.

48. The multi-stacked perimeter assembly of claim 47, further comprising a third perimeter component having a third width and being configured to be removably attached to a second side of the second connector.

49. The multi-stacked perimeter assembly of claim 48, further comprising a fourth perimeter component having the first width and being configured to be removably attached to the first side of the first connector and stacked vertically on top of the first perimeter component.

50. The multi-stacked perimeter assembly of claim 49, further comprising a fifth perimeter component having the second width and being configured to be removably attached to the second side of the first connector, removably attached to the first side of the second connector, and stacked on top of the second perimeter component.

51. The multi-stacked perimeter assembly of claim 50, further comprising a sixth perimeter component having the third width and being configured to be removably attached to the second side of the second connector and stacked vertically on top of the third perimeter component.

52. The multi-stacked perimeter assembly of claim 51, further comprising a seventh perimeter component having the first width and being configured to be removably attached to the first side of the first connector and stacked vertically on top of the fourth perimeter component.

53. The multi-stacked perimeter assembly of claim 52, further comprising an eighth perimeter component having a fourth width and being configured to be removably attached to the second side of the first connector and stacked vertically on top of the fifth perimeter component, the second connector, and the sixth perimeter component, wherein the fourth width is equal to a sum of the second width, a width of the second connector, and the third width.

54. A multi-stacked perimeter assembly for a skating rink, the assembly comprising:
the connector of claim 1;
a first perimeter component having a first height and being configured to be removably attached to a first side of the connector; and
a second perimeter component having a second height and being configured to be removably attached to a second side of the connector,
wherein the first height is less than the second height.

55. The multi-stacked perimeter assembly of claim 54, further comprising a third perimeter component having a third height and being configured to be removably attached to the first side of the connector and stacked vertically on top of the first perimeter component, wherein a sum of the first height and the third height is greater than the first height.

56. The multi-stacked perimeter assembly of claim 55, further comprising a fourth perimeter component having a fourth height and being configured to be removably attached to the second side of the connector and stacked vertically on top of the second perimeter component, wherein the sum of the first height and the third height is less than a sum of the second height and the fourth height.

57. The multi-stacked perimeter assembly of claim 56, further comprising a fifth perimeter component having a fifth height and being configured to be removably attached to the first side of the connector and stacked vertically on top of the third perimeter component, wherein a sum of the first height, the third height, and the fifth height is greater than the sum of the second height and the fourth height.

58. The multi-stacked perimeter assembly of claim 57, further comprising a sixth perimeter component having a sixth height and being configured to be removably attached to the second side of the connector and stacked vertically on top of the fourth perimeter component, wherein the sum of the first height, the third height, and the fifth height is equal to a sum of the second height, the fourth height, and the sixth height and is equal to a height of the connector.

59. A multi-stacked perimeter assembly for a skating rink, the assembly comprising:
a first perimeter component having a first height;
a second perimeter component having a second height and being configured to be removably attached to the first perimeter component; and
a third perimeter component having a third height and being configured to be removably attached to the second perimeter component and stacked vertically on top of the first perimeter component,
wherein a sum of the first height and the third height is greater than the second height.

60. The multi-stacked perimeter assembly of claim 59, further comprising a fourth perimeter component having a fourth height and being configured to be removably attached to the third perimeter component and stacked vertically on top of the second perimeter component, wherein the sum of the first height and the third height is less than a sum of the second height and the fourth height.

61. The multi-stacked perimeter assembly of claim 60, further comprising a fifth perimeter component having a fifth height and being configured to be removably attached to the fourth perimeter component and stacked vertically on top of the third perimeter component, wherein a sum of the first height, the third height, and the fifth height is greater than a sum of the second height and the fourth height.

62. The multi-stacked perimeter assembly of claim 61, further comprising a sixth perimeter component having a sixth height and being configured to be removably attached to the fifth perimeter component and stacked vertically on top of the fourth perimeter component, wherein the sum of the first height, the third height, and the fifth height is equal to a sum of the second height, the fourth height, and the sixth height.

63. The multi-stacked perimeter assembly of claim 59, wherein the attachment of the second perimeter component to the first perimeter component and the attachment of the attachment of the third perimeter component to the second perimeter component vertically stabilizes the third perimeter component.
